(19) United States
(12) Patent Application Publication
(10) Pub. No.: US 2008/0270214 A1
(43) Pub. Date: Oct. 30, 2008

(54) System and Process for Managing the Preparation of a Bid Document in Response to a Tender

(75) Inventors: Donna Eiby, Potts Point (AU); Wendy Knobel, Newtown (AU)

Correspondence Address: SEED INTELLECTUAL PROPERTY LAW GROUP PLLC, 701 FIFTH AVE, SUITE 5400, SEATTLE, WA, 98104, US

(73) Assignee: Bid Management International Pty Ltd., Potts Point (AU)

(21) Appl. No.: 11/629,841

(22) PCT Filed: Jun. 17, 2005
(86) PCT No.: PCT/AU05/00874

§ 371 Date: Feb. 15, 2008

(30) Foreign Application Priority Data
Jun. 18, 2004 (AU) 2004903340

(51) Int. Cl. G06Q 10/00

(52) U.S. Cl. 705/9

(57) ABSTRACT

A system for managing the preparation of a bid document in response to a tender receives clauses selected from a tender document and categorises each clause into one of a plurality of clause categories. An author association component of the system associates each clause categorised as a response requirement with a response author. A messaging component sends a response template including at least one response requirement to an associated response author, and receives the completed response template from the response author. A bid document generator generates a bid document on the basis of the response text received from response authors.

### FIELD OF THE INVENTION

The present invention relates to a system and process for managing the preparation of a bid document in response to a tender.

### BACKGROUND

In recent years, many organisations and government bodies have changed their business practices to outsource the provision of goods and services in respect of many aspects of their business. In Australia alone, approximately 50,000 open tenders and 35,000 closed tenders were advertised through one tender information service in 2002. For each tender released, between 1 and 10 suppliers responded, representing between 85,000 and 850,000 tender responses, referred to as bids. Typically, a tender includes a very large number of specifications and requirements that a bidder must respond to. Thus the process of preparing a bid document in response to a tender can be extremely complex and time-consuming due to the large number of tender requirements, which typically require responses from a team of people with vastly differing areas of expertise, and who may be distributed over various physical locations. As a consequence, the complexity of managing the process of preparing a bid in the often tight timelines specified by the tender is simply beyond the capabilities of many organisations, and organisations that can effectively manage all of the processes and issues involved are at a significant advantage over competing organisations. These organisations will be successful in bidding for tenders, and their businesses will flourish. Other organisations may have the technical expertise to fulfil the requirements of the tender, but may lack the organisational and managerial expertise to successfully prepare the document in the time required.

It is desired to provide a system and process for managing the preparation of a bid document in response to a tender that alleviate one or more of the above difficulties, or at least provide a useful alternative.

### SUMMARY OF THE INVENTION

In accordance with the present invention, there is provided a system for managing the preparation of a bid document in response to a tender, the system including:
a clause categorisation component for receiving clause data including a plurality of clauses selected from a tender document and for categorising each of said clauses by associating each clause with a clause category selected from a plurality of predetermined clause categories;
a database for storing said clause data and the clause category associated with each clause of said clause data;
an author association component for associating each clause categorised as a response requirement with a corresponding response author;
a messaging component for sending a response template including at least one response requirement to a response author associated with the at least one response requirement, and for receiving a corresponding completed response template from said response author, the completed response template including response text prepared by said response author in response to the at least one response requirement; and
a bid document generator for generating a bid document on the basis of the response text received from response authors associated with the response requirements of the tender document.

The present invention also provides a system for managing the preparation of a bid document in response to a tender, the system including:
a task generation component for selecting tasks for preparing the bid document from a plurality of predetermined tasks, and for associating with each of the selected tasks a due date for completion of the task and a user responsible for said completion;
a task status component for updating status data associated with each selected task, the status data including the due dates for completion of said tasks and completion data indicating dates on which respective tasks were completed by users responsible for completion of said tasks; and
a bid status component for generating status display data representing the status of each task on the basis of the due dates associated with said tasks.

The present invention also provides a process for managing the preparation of a bid document in response to a tender, the process executed by a computer system and including:
receiving clause data including a plurality of clauses selected from a tender document;
categorising each of said clauses by associating each clause with a clause category selected from a plurality of predetermined clause categories;
associating each clause categorised as a response requirement with a corresponding response author;
sending a response template including at least one response requirement to a response author associated with the at least one response requirement;
receiving a corresponding completed response template from said response author, the completed response template including response text prepared by said response author in response to the at least one response requirement; and
generating a bid document on the basis of the response text received from response authors associated with the response requirements of the tender document.

The present invention also provides a process for managing the preparation of a bid document in response to a tender, the process including:
selecting tasks for preparing the bid document from a plurality of predetermined tasks;
associating with each of the selected tasks a due date for completion of the task and a user responsible for said completion;
maintaining status data associated with each selected task, the status data including the due dates for completion of said tasks and completion data indicating dates on which respective tasks were completed by users responsible for completion of said tasks; and
generating status display data representing the status of each task on the basis of the due dates associated with said tasks.

The present invention also provides a system having components for executing the steps of any one of the above processes.

The present invention also provides a computer readable storage medium having stored thereon program code for executing the steps of any one of the above processes.

### BRIEF DESCRIPTION OF THE DRAWINGS

A preferred embodiment of the present invention is hereinafter described, by way of example only, with reference to the accompanying drawings, wherein:

FIG. 1 is a block diagram of a preferred embodiment of a bid management system;

FIG. 2 is a flow diagram of a bid management process executed by the bid management system;

FIG. 3 is a flow diagram of a task list generation process of the bid management process;

FIG. 4 is a flow diagram of a bid project creation process of the bid management process;

FIG. 5 is a flow diagram of a bid project establishment process of the bid management process;

FIG. 6 is a flow diagram of a bid project management process of the bid management process;

FIG. 7 is a flow diagram of a tender document import and clause categorisation process of the bid management process;

FIG. 8 is a flow diagram of a response management process of the bid management process;

FIG. 9 is a flow diagram of a bid document compilation process of the bid management process;

FIGS. 10 and 11 are screenshots generated by the bid project creation process;

FIGS. 12 to 23 are screenshots generated by the bid project establishment process;

FIGS. 24 to 27 are screenshots generated by the bid project management process;

FIGS. 28 to 48 are screenshots generated by the tender document process; and

FIGS. 49 to 51 are screenshots generated by the bid document compilation process.

### DETAILED DESCRIPTION OF THE PREFERRED EMBODIMENT

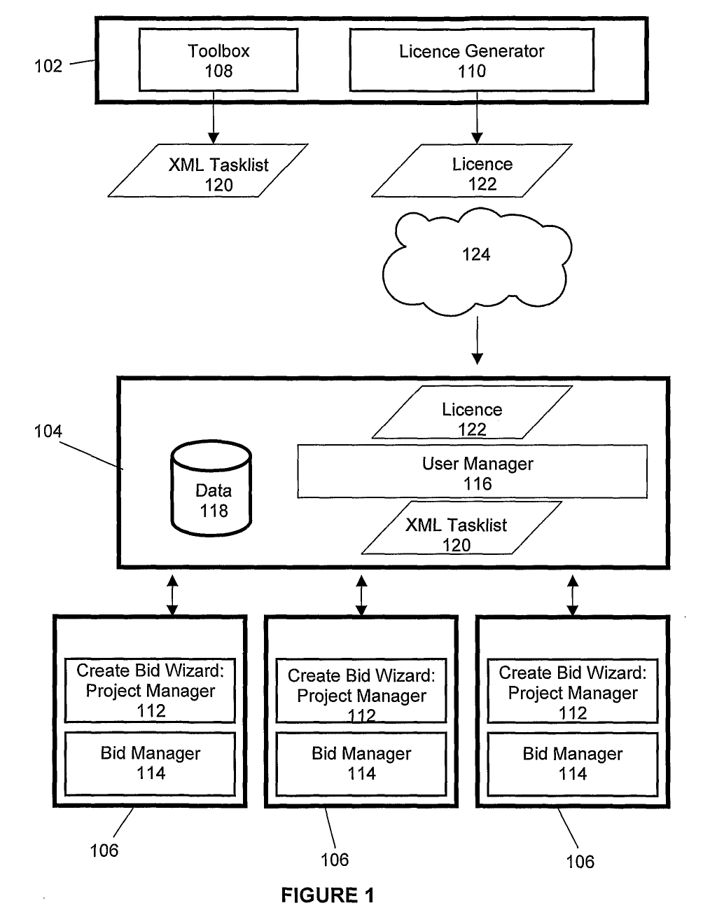

As shown in FIG. 1, a bid management system includes an initialisation system 102, a server 104 and client systems 106. The initialisation system 102 includes a toolbox 108 and a licence generator 110. Each of the client systems 106 includes a create bid wizard 112, and a bid manager 114. The server 104 includes a user manager 116 and a database 118. The bid management system executes a bid management process that manages the preparation and submission of a bid document in response to an advertised tender for goods and/or services. In the described embodiment, the initialisation system 102, the server 104 and the client systems 106 are standard computer systems such as Intel IA-32 or IA-64 based computer systems executing a Windows operating system, and the bid management process is implemented as software modules, being the bid management modules 108 to 116 executed by the computer systems 102 to 106. The database 118 is a standard structured query language (SQL) database. However, it will be apparent to those skilled in the art that the modules of the bid management system can be distributed over a variety of alternative locations, and that at least parts of the bid management process can alternatively be implemented by dedicated hardware components, such as application-specific integrated circuits (ASICs).

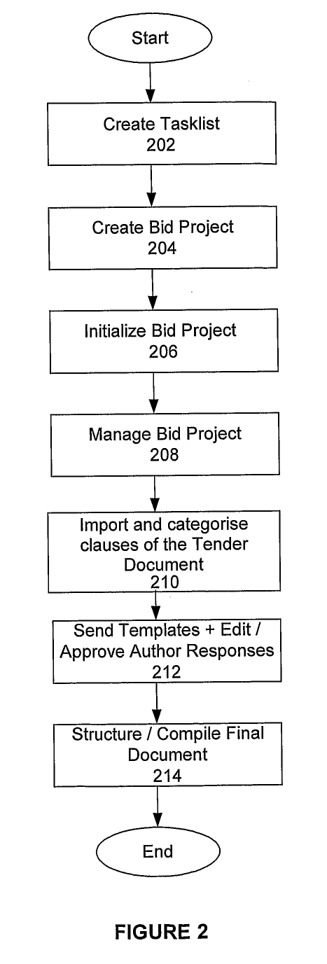

The bid management system is provided by an organisation referred to as the system provider to an organisation referred to as the bidding organisation or bidder, who wishes to respond to an advertised tender. The initialisation system 102 is located on the system provider's premises, whereas the server 104 and client systems 106 are located in one or more sites of or otherwise associated with the bidder. The bidder uses the bid management process, as shown in FIG. 2, to manage the preparation and submission of a bid document in response to the tender.

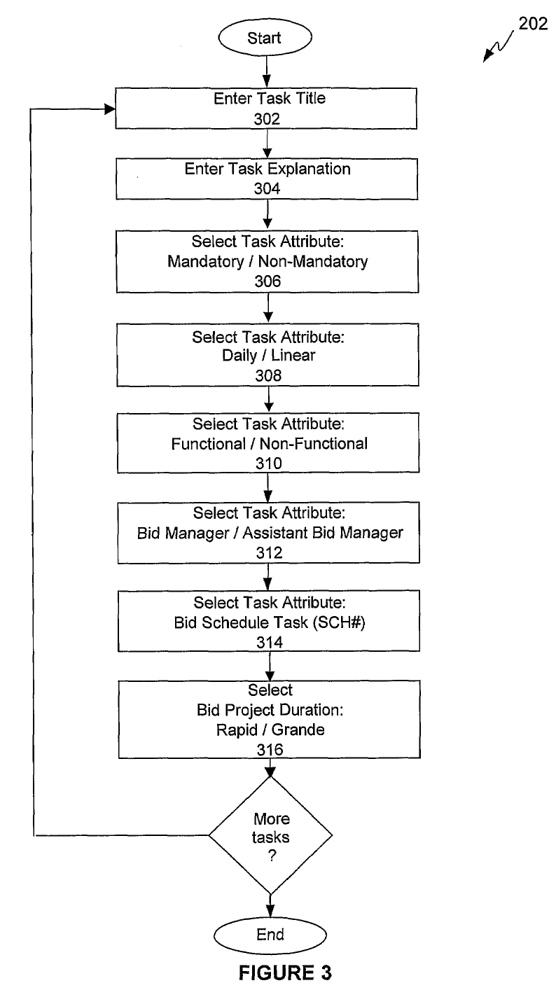

The bid management process begins at step 202 by creating on the initialisation system 102 a master list of all possible tasks involved in the preparation and submission of a bid document. This list is created by executing a task generation process 202, as shown in FIG. 3. An employee of the system provider enters information on each task, as described below, based on the system provider's bid management methodology. The task list is created in XML format, using the toolbox 108. Each task in the list is associated with task data, such as the task title, a textual explanation of the task, and one or more associated attributes, as follows. At step 302, the current task is given a title or name. At step 304, the employee enters explanatory text that explains the nature of the task. Steps 306 to 316 assign various attributes to the task. At step 306, an attribute is assigned to indicate whether the task is mandatory or non-mandatory. At 308, the task is assigned an attribute indicating whether the task is daily or linear: a daily task is scheduled to be redisplayed to a user for execution once every 24 hours, in contrast to a linear task, which needs to be performed once only. At step 310, an attribute is assigned to indicate whether the task is functional or non-functional. A functional task is a task that is at least partly performed by the bid management system, as opposed to non-functional tasks that are performed manually by a user. For example, a task named “Import Tender Document” is assigned a functional attribute. Subsequently, a user can cause the system to perform the corresponding function—in this case to import a tender document—via clicking on the task name in a displayed list of tasks using a pointing device such as a mouse, as described below. Although the functions performed by the system can alternatively be performed by selecting a corresponding item from a drop-down menu, the use of functional attributes allows the bid management process to be entirely driven by selecting tasks from a displayed list. This greatly facilitates the preparation of a bid document as the user is guided by the unidirectional nature of the displayed list of ordered tasks customised for the particular bid.

At step 312, an attribute is assigned to the task to indicate whether the task can only be performed by a user identified as a Bid Manager or can also be performed by an Assistant Bid Manager, as described below. Due to their critical nature, certain tasks are preferably conducted by the Bid Manager. If the Bid Manager attribute is selected for a particular task, a warning is displayed if that task is subsequently assigned to an Assistant Bid Manager. However, the assignment is not prevented. At step 314, an attribute is assigned a schedule number that is used for task scheduling, as described below. Finally, an attribute is assigned to indicate whether the task is for use in preparing a rapid or abbreviated bid project, or a ‘grande’ or complete bid project, as described below. Steps 302 to 316 are performed for each task in the task list. The result is a task list 120 in extended mark-up language or XML, including the task data encoded in XML. The XML task list 120 is usually provided on a CD-ROM, together with installation files for the modules 112 to 118 of the bid management system. This installation CD-ROM is sent to the bidder. However, the system provider can alternatively customise the XML task list 120 provided on the CD-ROM to a particular bidder, if desired. Once installed, the XML task list 120 is installed on the bidder's server 104 where it can be read by client applications 112, 114 installed on the bidder's computer systems 106. However, before the bidder can actually use these client applications 112, 114 to manage a bid, a licence file 122 is installed on the bidder's server 104. The licence file 112 is generated on the installation system 102 by the licence generator 110, and is sent to the bidder on a computer readable storage medium, such as a floppy disk or CD-ROM, or via a communications network 124, such as the Internet. Returning to FIGS. 1 and 2, once the bid management modules 112 to 118 and the XML task list 120 and licence file 122 have all been installed on the bidder's computer systems 104, 106, the bidder can now use the system to prepare bids for one or more tenders.

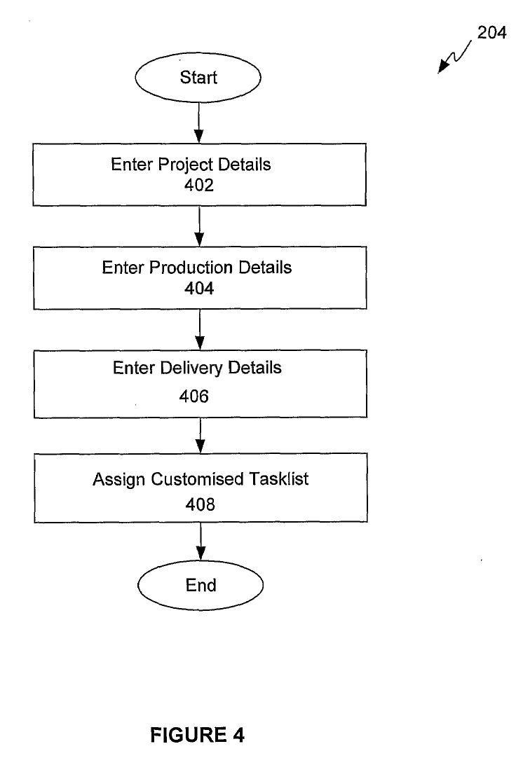

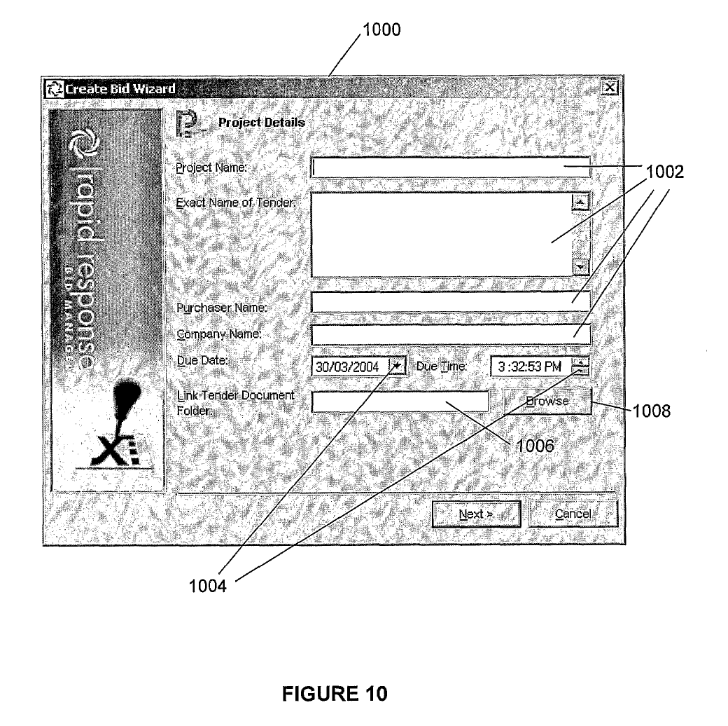

The create bid wizard 112 installed on each of the bidder's client computer systems 106 is a stand-alone application that executes a bid project creation process 204, as shown in FIG. 4, in order to create a new bid project for the tender. Each user of the bid management system modules 112 to 116 is assigned a username and password that are stored in the database 118. When the bid wizard 112 is first executed, a user enters their name and password, and these are validated against the copies stored in the database 118. At step 402, the user enters the project details in a project details window 1000, as shown in FIG. 10. The project details window 1000 provides textboxes 1002 for entering the name of the new project, the exact name of the tender for which the bid is a response, the name of the tendering party, referred to as the purchaser, and the company name of the bidder. The due date and time of the bid are entered using controls 1004 and the directory or folder in which the bid documents are to be stored is either entered in a textbox 1006 or selected from a file system browser accessed by selecting a Browse button 1008.

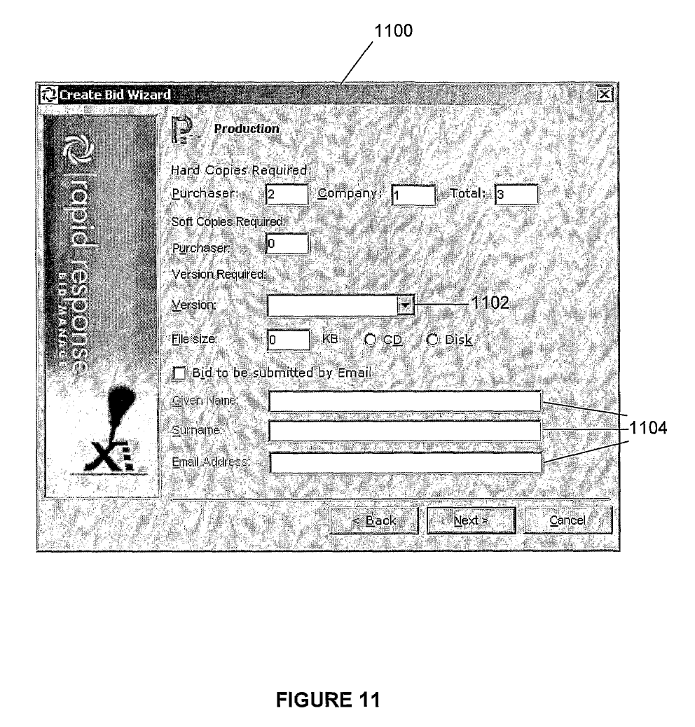

Once the project details have been completed, at step 404 the user can enter production details into a production window 1100, as shown in FIG. 11. The production details include the number of hardcopies of the bid document required by the purchaser and by the bidder, and the number of soft (i.e., electronic) copies of the bid document required by the purchaser. The particular electronic format of the bid document is selected from a list of possible formats in a drop-down menu 1102. A maximum file size, if any, can be entered and the user can specify whether the soft copy of the bid document is to be provided on a CD-ROM, or disk, and/or sent via email. The name and email address of the responsible person of the purchaser are provided in textboxes 1104. At step 406, delivery details are entered by providing a recipient's name, address details and any delivery notes in a delivery details window (not shown). At step 408, the number of days remaining for the bid period (from project establishment to bid submission date) is determined and compared with a configurable period (having a default value of 10 days) stored in the database 118. If the bid period is less than the configured period value, then a bid length prompt window (not shown) is displayed to the user, indicating that due to the limited time available, the bid has been categorised as rapid, and allowing the user to accept this categorisation, or reject it in order to categorise the bid as a full, or ‘Grande’ bid. If the rapid categorisation is accepted by the user, the create bid wizard 112 selects tasks that have been assigned the rapid attribute from the XML task list 120 stored on the bidder's computer system 104. Otherwise, the bid is categorised as a full or ‘Grande’ bid, and all of the tasks in the XML task list 120 are selected. The selected tasks are stored in the database 118 as the bid tasklist. However, the stored tasklist can be further customised if desired, as described below. The bid project has now been created, and the user who created the bid project is designated as the bid manager for the project. The bid wizard 112 then terminates.

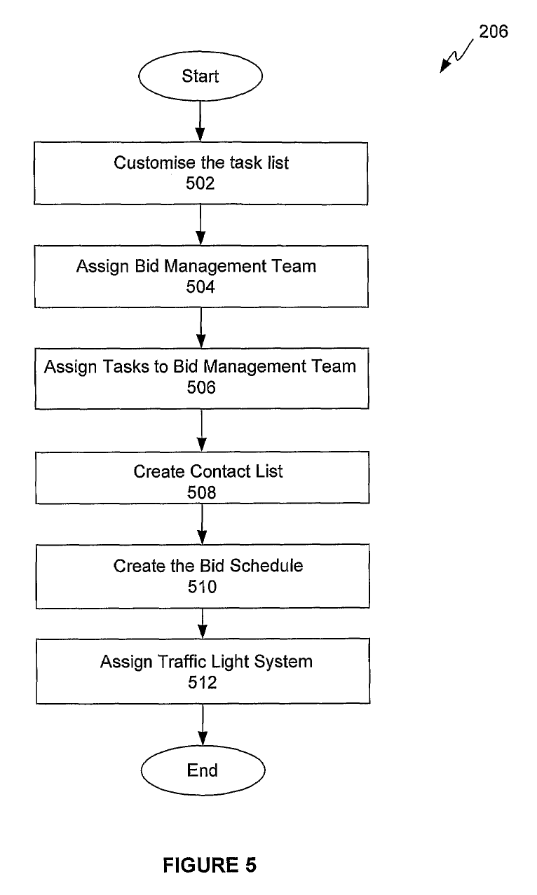

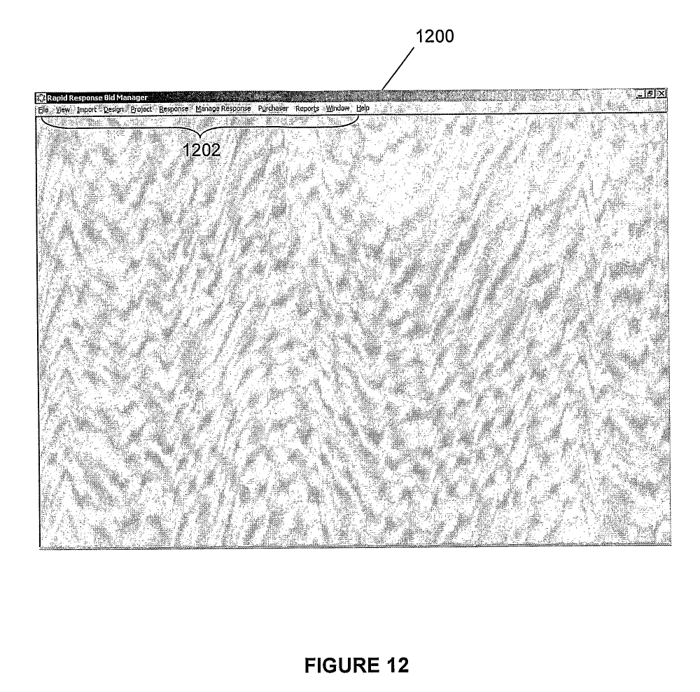

Once the bid project has been created, it can be accessed by executing the bid manager 114. When the bid manager 114 starts up, a bid manager window 1200 is displayed, as shown in FIG. 12. The bid manager window 1200 provides menus 1202 that can be used to perform various functions of the bid manager 114. In particular, returning to FIG. 2, once the bid project has been created at step 204, the bid manager initialises the bid project at step 206 by executing a bid initialisation process, as shown in FIG. 5, which begins at step 502 by customising the task list 120.

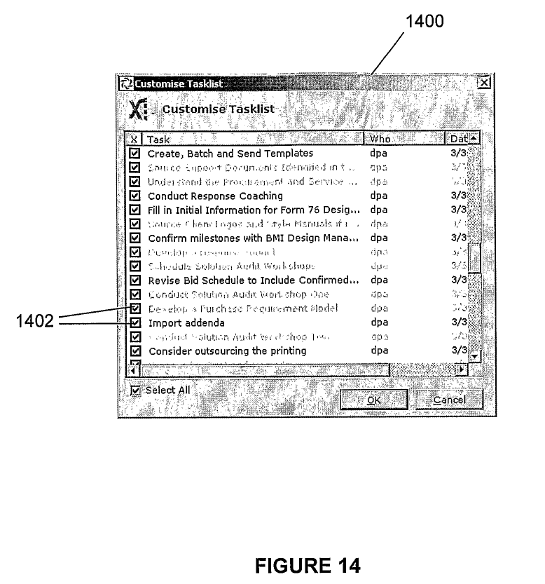

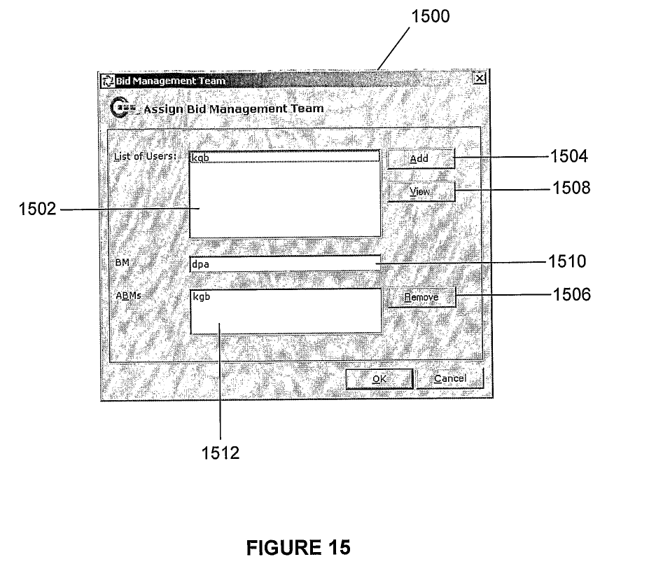

As shown in FIG. 14, a Customised Task List window 1400 displays a scrollable list of the tasks in the task list for the bid, and provides checkboxes 1402 that the user can select in order to include or exclude a particular task from the task list for the bid project. After customising the task list at step 502, a bid management team is assigned at step 504, using an assigned Bid Management Team window 1500, as shown in FIG. 15. This window 1500 displays a list of users 1502 known to the system. One or more users in this list can be added or removed from the current bid project team using an Add User button 1504 and/or a Remove User button 1506. Particular details of a selected user can be viewed by selecting a View User button 1508. As described above, the user who created the bid project is designated as the Bid Manager (BM). The Bid Manager can perform any task on the task list, and is responsible for overseeing the bid project. The other users on the team are assistant bid managers (ABMs) whose usernames displayed in an ABM textbox 1512. An assistant bid manager can perform any task except for those restricted for use by the bid manager (i.e., those tasks with the Bid Manager attribute set), as described above.

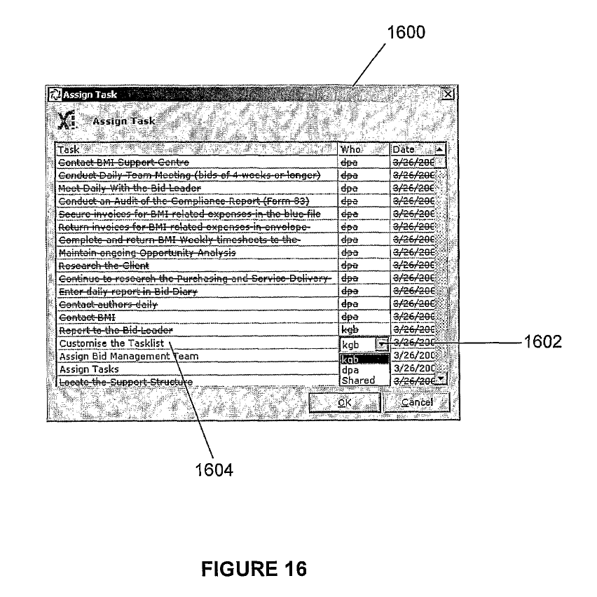

Once the bid management team has been assigned, at step 506 individual tasks are assigned to individual users of the bid management team, using an Assign Task window 1600, as shown in FIG. 16. This window 1600 displays the name of each task, the user assigned to perform the task, and the date on which that task is due for completion. A member of the bid management team is assigned to a task by selecting their username from a pull-down menu 1602 displayed adjacent the task name 1604. Any tasks that are already completed are shown struck-out. Any tasks that have already been removed from the tasklist for the current bid project using the Customised Task List window 1400 are not displayed.

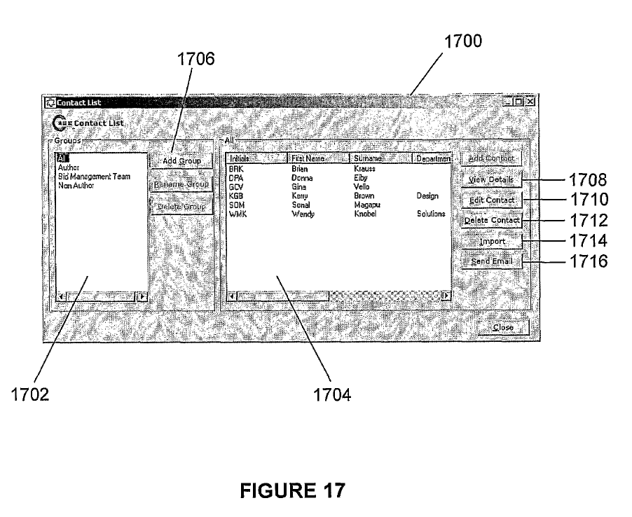

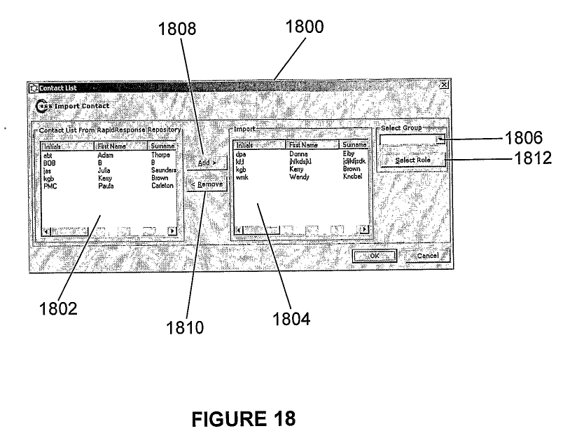

Contact lists are useful for contacting a group of users relevant to a particular role as a single entity. As shown in FIG. 17, a Contact List window 1700 allows an email to be sent to all of the members of a selected group of users as a single entity by selecting a send email button 1716. At step 508, one or more contact lists can be generated for the project using the Contact List window 1700. The Contact List window 1700 includes a group panel 1702 and a group members panel 1704. The group panel 1702 provides a list of all the groups already created for the bid project. Initially, the groups present are the group All, which includes all Contacts in the other Contact Lists; an Authors group, which includes all Contacts designated as Authors, as described below; a Non-Authors group, which includes all Contacts designated as Non-Authors, and a Bid Management Team group which includes all Users (ABMs) assigned to the Bid Project. However, additional groups can be created by selecting a Add Group button 1706. For example, an organisational specific group can be added and populated with selected users. Selection of a particular group name in the group panel 1702 results in display of the members of that group in the group members panel 1704. Selection of a particular user in the group members panel 1704 allows the details of that user to be viewed or edited by selecting the respective button 1708, 1710. A user can be removed from a selected group by selecting a Delete Contact button 1712. An Import Contact button 1714 allows a Contact known to the bid management system but not associated with the current bid project to be added to the project using an Import Contact window 1800, as shown in FIG. 18. The Import Contact window 1800 displays a left panel 1802 listing all users and contacts known to the bid management system, such as users and contacts associated with other bid projects. A right hand panel 1804 displays a list of users and contacts assigned to the Contacts List for the particular Bid Project. A user selected from the left hand panel 1802 can be added to the list displayed in the right hand panel 1804 by selecting an Add Contact button 1808, and can be removed by selecting a Remove Contact button 1810. A Select Role button 1812 allows a selected user to be designated in a particular role and to a particular Group; e.g., as an Author, Non-Author, etc.

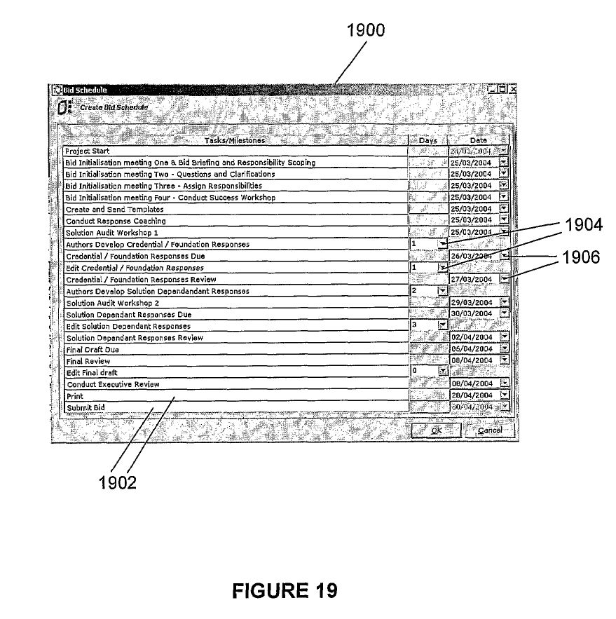

At step 510, a bid schedule can be created using a Create Bid Schedule window 1900, as shown in FIG. 19. The Create Bid Schedule window 1900 allows the user to assign either a number of days required or a completion date with each major task or milestone of the project, defined at step 202. The number of days required to complete each task or milestone, or the date upon which the task or milestone is due, are selected using drop-down menus 1904 and 1906, respectively. The bid schedule provides a high level overview of the major stages of bid preparation, and allows the progress and status of the bid project to be easily monitored, as described below.

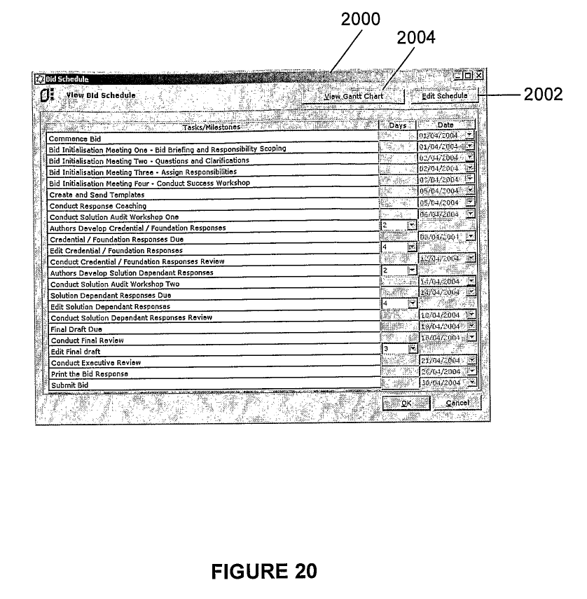

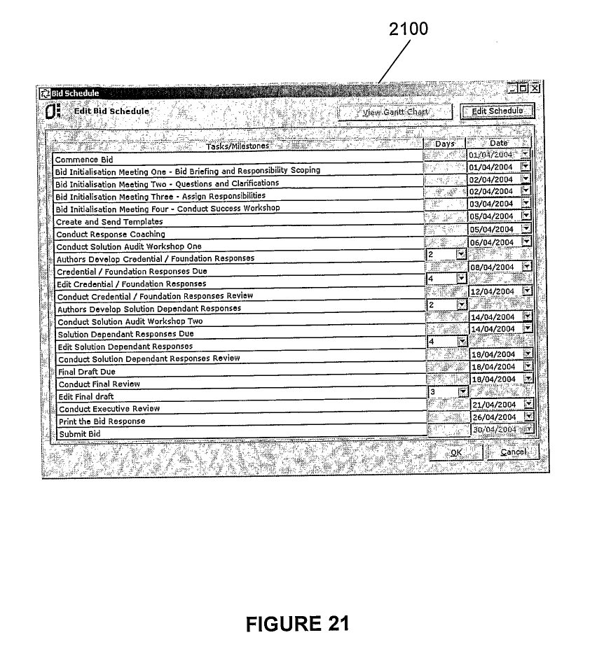

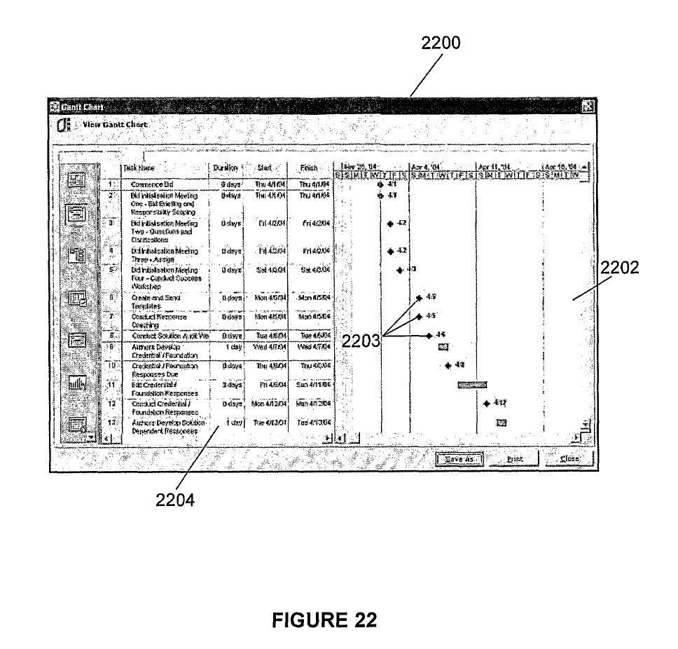

Once the bid schedule has been created, it can be viewed using a View Bid Schedule window 2000, as shown in FIG. 20. The View Vid Schedule window 2000 displays a list of the tasks/milestones defined for the current project, and, for each task/milestone, either the number of days remaining or the completion date, and these can be edited by selecting a Edit Schedule button 2002. This causes the bid management system to display a Edit bid schedule window 2100, as shown in FIG. 21, providing editable fields and menus identical to those in the Create Bid Schedule window 1900. Returning to FIG. 20, a user can select a View Gantt Chart button 2004 to display a Gantt Chart window 2200, as shown in FIG. 22. This window 2200 displays a Gantt Chart of the bid project in a right panel 2202, with the symbol 2203 displayed for each task aligned with entries in a left panel 2204 displaying the task name, duration, start date, and completion date. The Gantt Chart provides an easily understandable overview of the relative timings of the various tasks/milestones in the project and greatly facilitates completion of the bid by the due date.

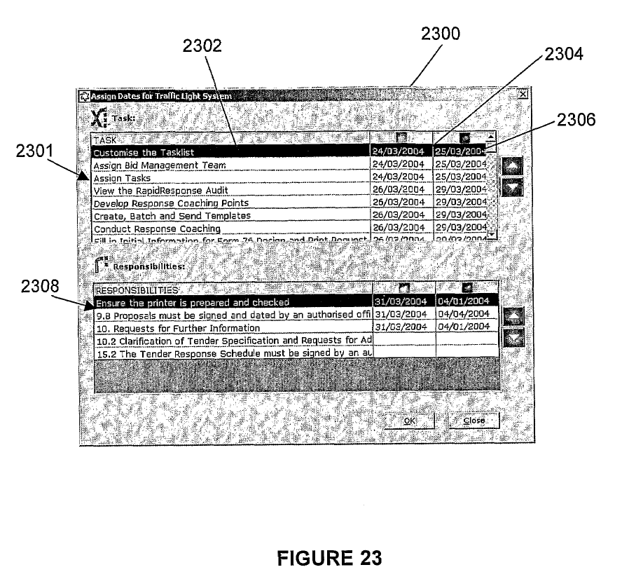

The bid management system uses traffic light icons to provide a readily comprehensible overview of the status of each task. At step 512, two dates are associated with each task in the task list, using a Task panel 2301 of a Traffic Light Date Assignment window 2300, as shown in FIG. 23. Each task in the task list is displayed in a left column 2302, and two columns 2304, 2306 to the right of the task name allow the user to enter dates associated with green and red traffic lights, respectively. Provided that the current date is earlier than the date entered in the column 2304 for the green traffic light, the traffic light indicator corresponding to that task will be displayed as a green light. Conversely, if the current date is later than the date entered in the column 2306 for the red traffic light, the status of that task will be indicated by a red traffic light, indicating that the task is past its due completion date. If the current date is greater than the green light date, but less than the red light date, the traffic light system will display an amber traffic light for that task, alerting users that the task's completion date is imminent.

The bid management system also allows various responsibilities to be defined and associated with particular users, as described below. A Responsibilities panel 2308 in the traffic light assignment window 2300 allows green and red traffic light dates to be associated with each responsibility in the same manner as that described above for tasks. This completes the bid project initialisation process 206, and the bid project is now completely configured and ready for use, by members of the bid team.

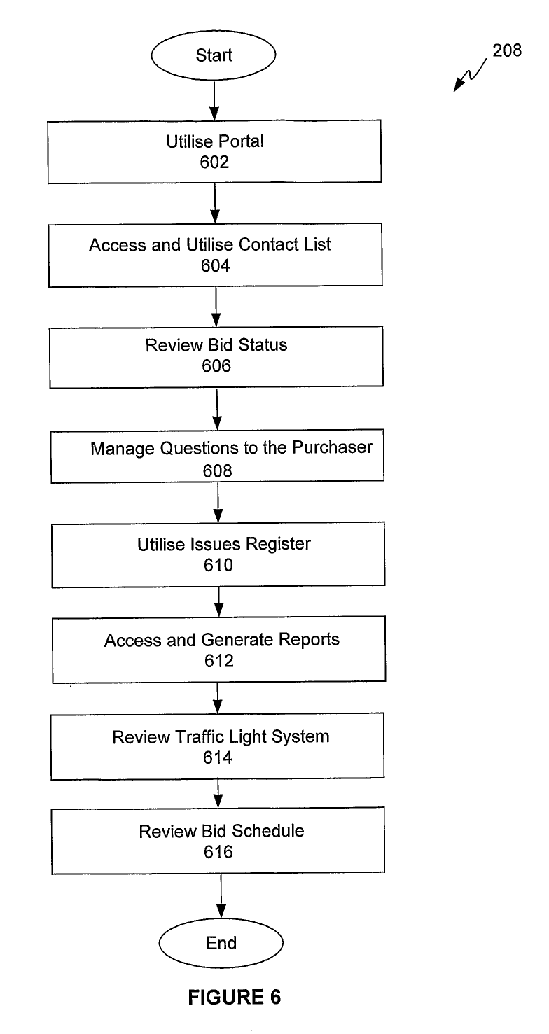

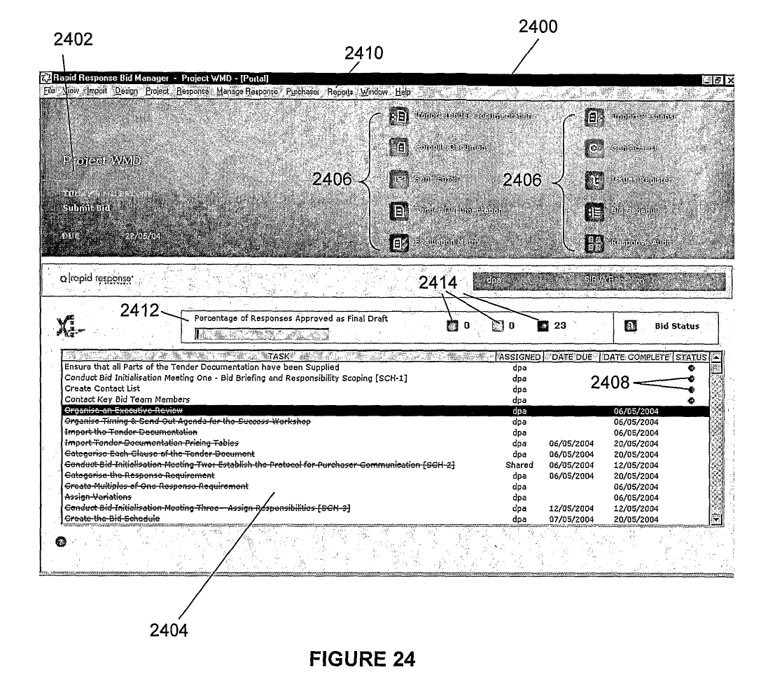

Returning to FIG. 2, a bid project management process 208, as shown in FIG. 6, provides various management functions 602 to 616 for bid projects. Although the bid project management process is represented as a linear flow diagram in FIG. 6, it should be understood that the steps of this process 208, and also the steps of processes 210 and 212, can be performed in any order. After the bid project is fully configured, the bid manager main window constitutes a portal 2400 into the system and includes a shortcut panel 2402, and a task status panel 2404, as shown in FIG. 24. The shortcut panel 2402 displays the name of the current project, together with any milestones due. Shortcut buttons 2406 provide single-click access to major functions of the bid management process, thus avoiding the need to navigate the menus 1202. The task status panel 2404 displays a scrollable list of all of the tasks for the bid project, together with the users assigned to those tasks. If a task has been completed, the date of completion is listed. Otherwise, the due date of the task is displayed, together with the status of the task as indicated by a traffic light icon 2408 of the appropriate colour, as described above. A bid project progress bar 2412 provides a readily comprehensible visual representation of the percentage of responses approved for the final draft of the bid document. Traffic light summary icons 2414 provide a summary of the traffic light status for all incomplete tasks, with the total number of tasks having a traffic light status of the appropriate colour displayed next to a representative traffic light icon of that colour.

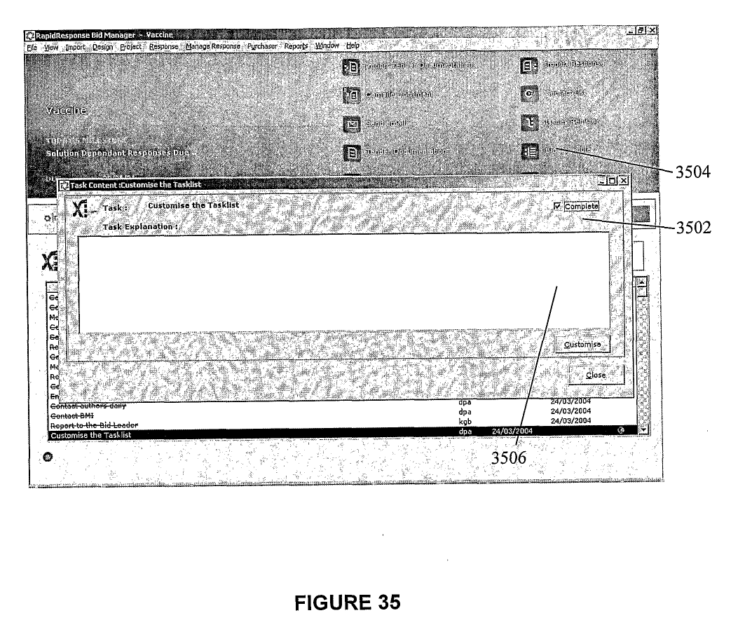

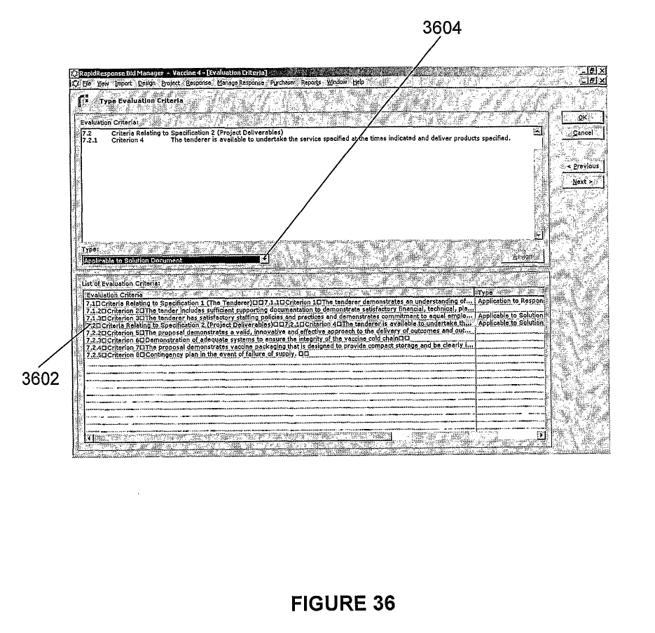

Double-clicking on a task in the Task Status panel 2404 results in a Task Explanation window being displayed, as shown in FIG. 35. An explanation textbox 3502 displays or accepts explanatory text for the selected task, and a Task Complete check box 3504 allows the user to indicate whether the task has been completed or not. If the selected task has been designated as a functional task, as described above, then a Task Function button 3506 (not shown) is also displayed. Selection of the Task Function button 3506 initiates the corresponding function of the bid management system. For example, the selected task in FIG. 35 is named “Customise the Tasklist”, and selection of the task function button 3506 (labelled “Customise” to reflect the corresponding function) in this case causes the bid management system to execute a tasklist customisation process, as described above with reference to FIG. 14.

At step 604, email messages can be sent to various users utilising the contact list, as described above.

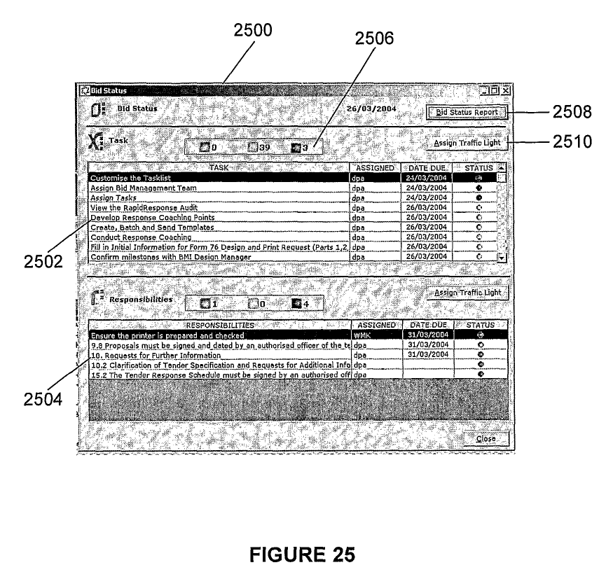

At step 606, a bid status can be reviewed using the portal 2400. Alternatively, a more detailed view of the bid status can be displayed by a Bid Status window 2500, as shown in FIG. 25. This window 2500 includes a Task Status panel 2502 and a Responsibility Status panel 2504. A task list traffic light summary 2506 provides numeric counts of the numbers of tasks in the green, amber, and red light categories, as described above. The dates associated with the traffic lights for each task can be modified if desired by selecting an Assign Traffic Light button 2510. The same capabilities apply to responsibilities listed in the Responsibility Status panel 2504. A Bid Status Report button 2508 can be selected to generate a document providing a status report of the bid project.

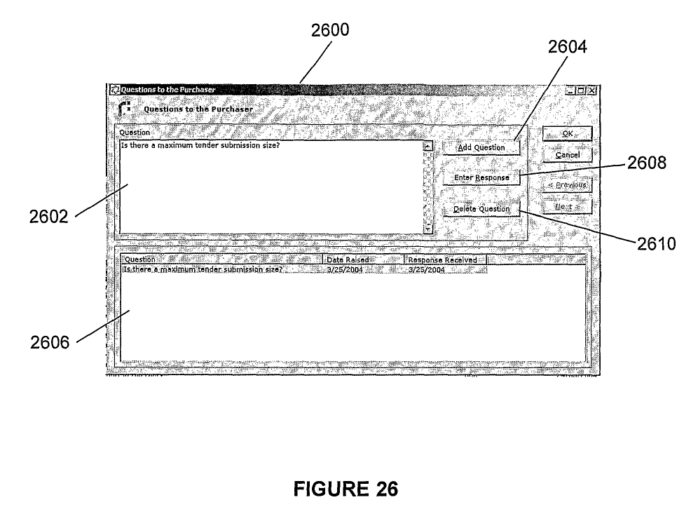

It is not uncommon that an organisation planning to bid in response to a tender may have a number of questions for the purchaser. At step 608, such questions can be stored and managed via a Purchaser Questions window 2600, as shown in FIG. 26. A question to be put to the purchaser can be entered in a Question textbox 2602. When the question has been entered, selection of an Add Question button 2604 adds the question to a list of questions displayed in a Question list 2606, which displays the first line of the question, together with the date the question was raised and the date a response was received, if any. An Enter Response button 2608 allows the response from the purchaser to be entered in a similar fashion. Questions can be deleted from the list of questions 2606 by selection of the question followed by selection of a Delete Question button 2610. The Purchaser Questions window 2600 provides a convenient single access point for managing questions put to the purchaser and the purchaser's responses to those questions.

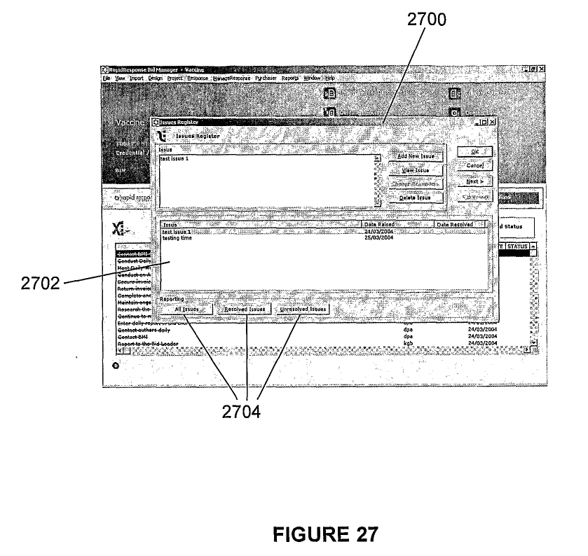

During the preparation of a bid, various issues internal to the bidder may arise. At step 610, these issues can be managed using an Issues Register window 2700, as shown in FIG. 27. The Issues Register window 2700 provides analogous features to those provided by the questions to the Purchaser window 2600 described above. The issues listed in an Issue List box 2702 can be filtered to display only resolved or unresolved issues, or all issues, using filter buttons 2704.

At step 612, reports can be accessed and/or generated by accessing report functions from the dropdown Reports menu 2410 of the portal 2400. Several reports can be generated, as follows.

A Contact List Report provides a summary of the contacts related to the bid project. For each contact, the report lists the contact's group, name, email address, desk phone, and mobile telephone number. The contact list report can be filtered by group or name.

A Bid Content Status Report provides a summary of the current status for a project. For each clause of the tender document imported into the system, this report lists the Location, Clause Name, Category, Variation—(Variation Name or EMPTY), Responsibility (username), Evaluation Criteria (YES/NO), Response Direction (YES/NO), and Response Category. This report can be filtered by category, or responsibility.

A Traffic Light Status Report summarises the current status of the traffic lights for the tasks and responsibilities of a project. The report provides the traffic light count totals for the project tasks, and for each task, the serial number, task name, assigned user, due date, and status. The report also includes the traffic light totals for responsibilities defined for the project, and for each responsibility, the serial number, responsibility name, assigned user, due date, and status.

A Daily'Task Report provides for each task defined as a daily task, the task's name, status, assigned user, most recent completion date, and the username of the user who most recently completed the task. The daily task report can be filtered by Status (All, Completed, Not Completed), Assigned To (username), or Completed By (username). The order of tasks in the report follows the order of the corresponding records in the database 118.

A Linear Task Report provides, for each task defined as a linear task, the task's name, status, assigned user, completion date, and the username of the user who completed the task. The Linear Task Report can be filtered by Status (All, Completed, Not Completed), Assigned User (User Name), and Completed By (User Name). The order of tasks in the report follows the order of the corresponding records in the database 118.

An Issues Register Report summarises the issues defined for the bid project as described above, listing for each issue, the Issue text, Status, Raised Date, Raised By (username), Resolved Date, Resolved By, and Resolution text. This report can be filtered by Status (All, Completed, or Not Completed).

A Response Coaching Points Report lists each response coaching point, its most recent author (Most Recent), the corresponding clause name, and the location of the clause. This report only includes coaching points for Response Requirements (clause category code Ds) and Additional Response Requirements (clause category code ARRs). This report can be filtered by Response Coaching Points (Blank OR Not Blank).

A Response Audit Report lists for each response received by the system, the response the Author, Version, Date/Time, Author (Most Recent), Send Date, Response Name, Response Coaching conducted (YES/NO), and Approved as Final Document (YES/NO).

At steps 614 and 616, the traffic light dates and bid schedule configured at steps 510 and 512 described above can be reviewed and updated if desired.

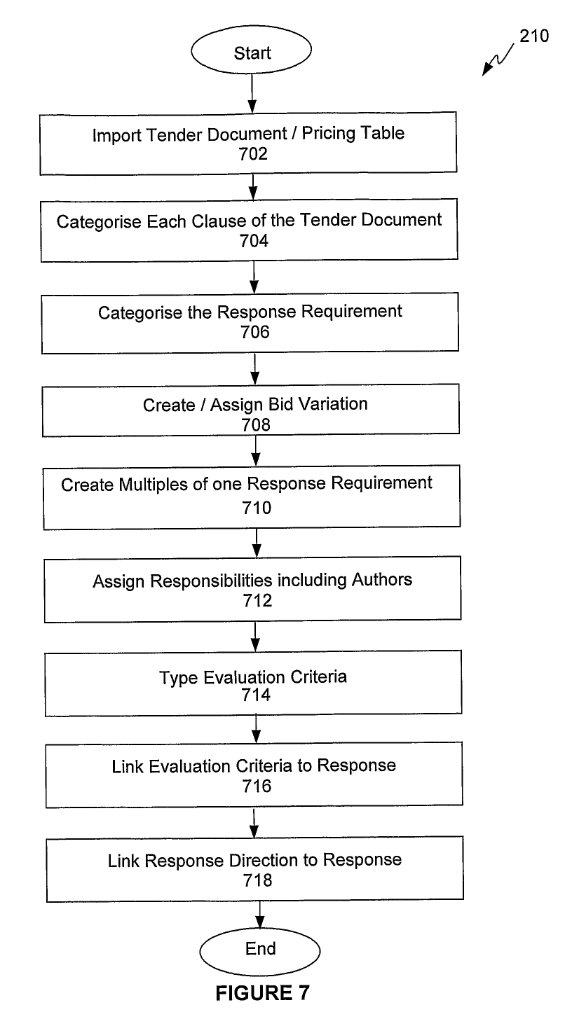

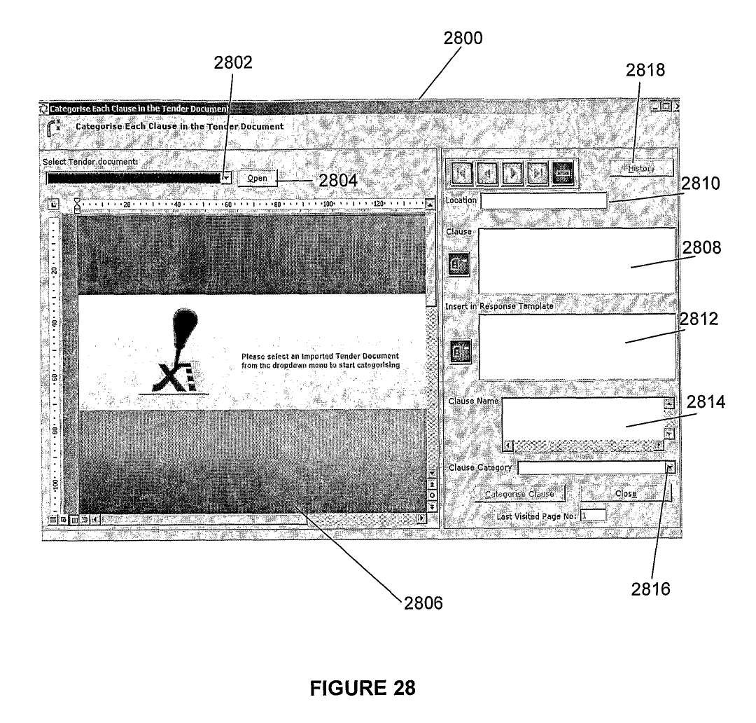

Each electronic tender document received by the bidder is imported into the bid management system by storing that document in the database 118. Returning to FIG. 2, a tender document import and clause categorization process 210, as shown in FIG. 7, allows individual clauses in one or more tender documents to be imported into the bid management system at step 702 and categorised using a Clause Categorization window 2800, as shown in FIG. 28.

A pull down Tender Document Selection menu 2802 allows any one of the imported tender document to be selected, and an open button 2804 then opens the selected document so that individual clauses of the document can be selected and categorised at step 704. Once a document is open, it is displayed in a scrollable document display panel 2806 on the left-hand side of the window 2800.

The user then types the name of the section of the imported tender document containing the clause into a Location text box 2810 so that the location of the clause in the tender document can be easily identified. Clauses in the tender document displayed in the document display panel 2806 can be selected and dragged or copied into a Clause text box 2808. This information is subsequently added to the compiled bid document with the responses received, as described below. Any text associated with the clause in the tender document and that is to be replicated in the bidder's response to the clause can be similarly dragged into a Response Template text box 2812 for inclusion in the final bid document. This response text can be edited if desired, and will be included below a header in response templates, as described below. Response text is only required to be entered into the Response Template text box 2812 if the corresponding clause is categorised as a Response Requirement.

A Clause Category pull down menu 2816 allows the user to select from a list of fifteen predefined category types and codes described below, as follows:
(i) A1—Responsibility;
(ii) A2—Condition of Tender;
(iii) DD—Delivery Direction
(iv) PD—Production Direction
(v) C—Condition of Contract
(vi) D—Response Requirement
(vii) ARR—Additional Response Requirement
(viii) RD—Response Direction
(ix) EC—Evaluation Criteria
(x) PO—Primary Output
(xi) SO—Secondary Output
(xii) OC-P—Outcome Procurement
(xiii) OC-SD Outcome Service Delivery
(xiv) KPI—Key Performance Indicator; and
(xv) VRN—Vendor Response Narrative.

A Responsibility (A1) clause defines a responsibility that is to be assigned to a member of the bid team. For example, a Responsibility might be to act as a point of contact for the Purchaser, or to attend data room openings. A typical Responsibility clause from a tender document might be “1.2 Tenders are to be lodged at the delivery address detailed in Schedule One”, which, when assigned to a member of the bid team requires that member to be responsible for the delivery of the bid document.

A Condition of Tender (A2) clause is a rule of the tender process, which might relate to collusive tendering, intellectual property, or tender validity period, for example. A typical A2 clause might be “3.8 Where there is any discrepancy between the content of the Tender received by e-mail and the confirming Tender, the contents of the Tender by e-mail shall prevail unless it can be shown conclusively by the Tenderer that an error occurred in transmission.”

A Delivery Direction (DD) clause provides delivery details to the Tenderer, such as where and when it is to be submitted, and by what method. For example, “3.5 Tenders are to be delivered by hand or delivered by Post or sent by e-mail to the contact officer.”

A Production Direction (PD) clause provides directions for producing the bid document, such as electronic format, fonts, packaging, binding). For example:
“3.10 The original and two copies of the Tender are to be lodged in single-sided A4 loose-leaf format. The original is to be marked as the original and each copy sequentially marked with a copy number. In the event of a discrepancy between any copy and the original, the original takes precedence. Copies of any supporting documents included with the Tender must also be included with each copy of the Tender.”

A Condition of Contract (C) clause is a clause provided by the Purchaser that does not fall into any of the other clause categories.

A Response Requirement (D) is a clause that requires a physical response in the submitted bid, such as clauses containing phrases such as “the Tenderer must”. These clauses are located in the Response Section of the Tender Documentation. For example:
“4.1.1 Tenderers will provide, in the appropriate response form at Attachment 1, the following information as part of their tenders:
(a) full legal name of Tenderer;
(b) any trading or business name;”

Additional Response Requirement (ARR) clauses are required responses that are not located in the Response Section of the Tender Documentation. Importantly, these are ultimately collected together into a single document entitled Additional Response Requirements and submitted as part of the bid. For example, “2.7.2 Tenderers must specifically respond in order to every condition, statement of requirement and query raised in the RFT.”

Response Direction (RDs) clauses provide the bidder with further information on how to respond to the tender. RD clauses can subsequently be linked to Response Requirements in order to provide the authors further assistance in developing their responses. For example:
“6.4 Specification 3: Rates and Budget;
6.4.1 Prices quoted should be competitive and commensurate with the key activities and outputs/deliverables required. Prices should be quoted as cost.”

Evaluation Criteria (EC) clauses define the criteria against which the tender will be evaluated, but are not always supplied in the tender documentation. However, these clauses are extremely important because the responses to the response requirement and additional response requirement clauses of the tender document(s) should always be developed while keeping in mind, as described below. The evaluation process through which the bid will pass after submission. For example, “7.1.1 Criterion 1 The tenderer demonstrates an understanding of service requirements. The tenderer has relevant and adequate experience, with demonstrated ability to deliver projects within prescribed timeframes and designated budgets.”

Primary Output (PO) clauses articulate the Purchaser's required deliverables under the subsequent contract (e.g., software development or helpdesk or courier services etc), deliverables for which they are willing to pay. Any such deliverables are itemised in the Pricing Schedule(s) to be submitted with the bid; if they are not in the Pricing Schedule, they are not a PO. For example:
“Data capture may be required to commence on the Sunday after polling day. The total quantity of certified lists from which data is to be captured is expected to be similar to that for the Federal election. Pricing for data capture is to be submitted in the supplied Schedule of Pricing.”

Secondary Output (SO) clauses articulate the Purchaser's required deliverables under the subsequent contract (e.g., account management, risk management, quality assurance), deliverables for which they are not willing to pay. They are not itemised in the Pricing Schedules to be submitted with the bid. If they are articulated as deliverables in the tender documentation, but are not in the Pricing Schedule, then they are SOs. For example:
“15.4 The Contractor agrees:
(a) at the times specified at Item H of Schedule 1, and at no additional cost to the X Corporation, to supply written security reports to the X Corporation in a manner and form specified by the X Corporation; and”

Outcome Procurement (OC-P) clauses define what the Purchaser requires to be the outcome of purchasing (e.g., value for money, meet strategic objectives). These should be a focus of the Solution Document, which is the section of the bid document that describes the bidders's proposed solution to the fundamental requirements of the tender. For example: “The objective of the purchase is to achieve value for money”.

Outcome Service Delivery (OC-SD) clauses define what the Purchaser requires to be the outcome of the service to be delivered under the contract (e.g., better service to end users, complete software package). These should be a focus of the Solution Document. For example: “The objective of the service is a seamless, 24/7 help desk function that meets the required levels of service”.

Key Performance Indicator (KPI) clauses define the levels that POs and SOs will be required to be delivered to (e.g., milestones, timings, quality), but are not always supplied in the tender documentation. KPI clauses are important as they will affect the service characteristics (timeliness, quality and cost). For example: “Services are required to be operational 98% of the time”.

Finally, Vendor Response Narrative (VRN) clauses are clauses that precede a Response Requirement in the Response Section of the Tender Documentation. For example:
“Tender Response Schedule For Supply for X Organisation's Services Program.
Note: These response schedules are available on diskette in electronic format [in Word for Windows format] on request from X Organisation at:
(Response Requirement) 4.1.1 Tenderers will provide, in the appropriate response form at Attachment 1, the following information as part of their tenders: (a) full legal name of Tenderer; (b) any trading or business name;”

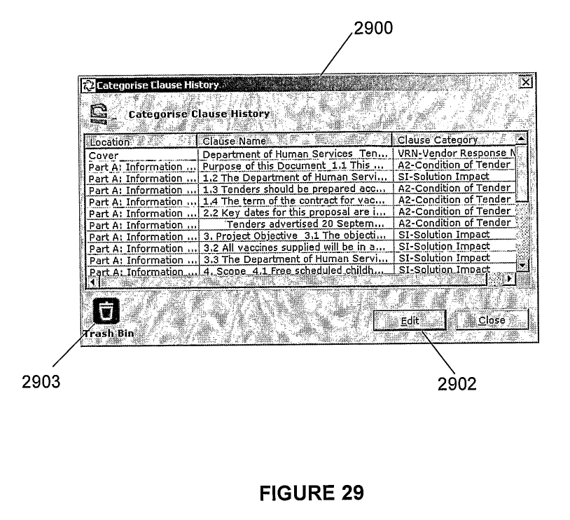

Returning to FIG. 28, selection of a Clause Categorization History button 2818 causes display of a Clause Categorization History window 2900, as shown in FIG. 29, which displays the location, name and category of each clause thus categorised. An Edit button 2902 allows the user to adjust the categorised clauses. A categorised clause can be deleted by selecting it from the list and dragging it onto a trash bin icon 2903.

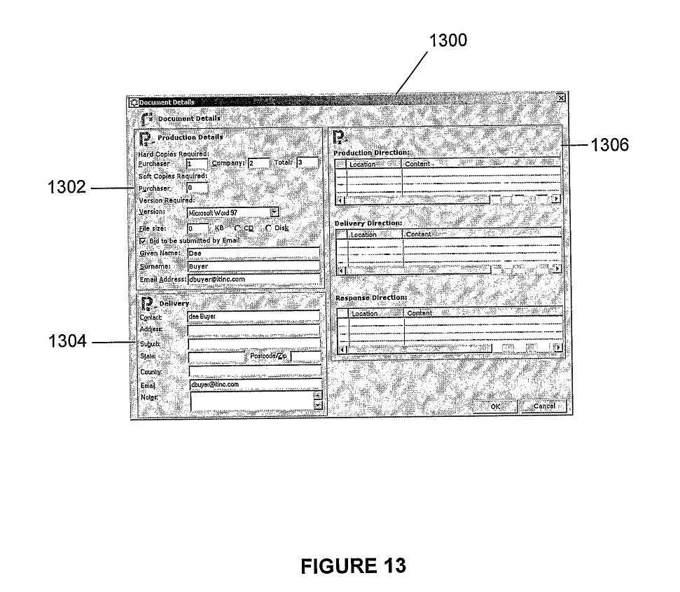

Details of the bid document can be viewed via a Document Details window 1300, as shown in FIG. 13. This displays the production details 1302 and delivery details 1304 that were previously entered using the bid wizard 112. A Production Direction panel 1306 displays all clauses given the PD attribute, a Delivery Direction panel displays all clauses given the DD attribute, and a Response Direction panel displays all clauses given the RD attribute and not linked to a response requirement.

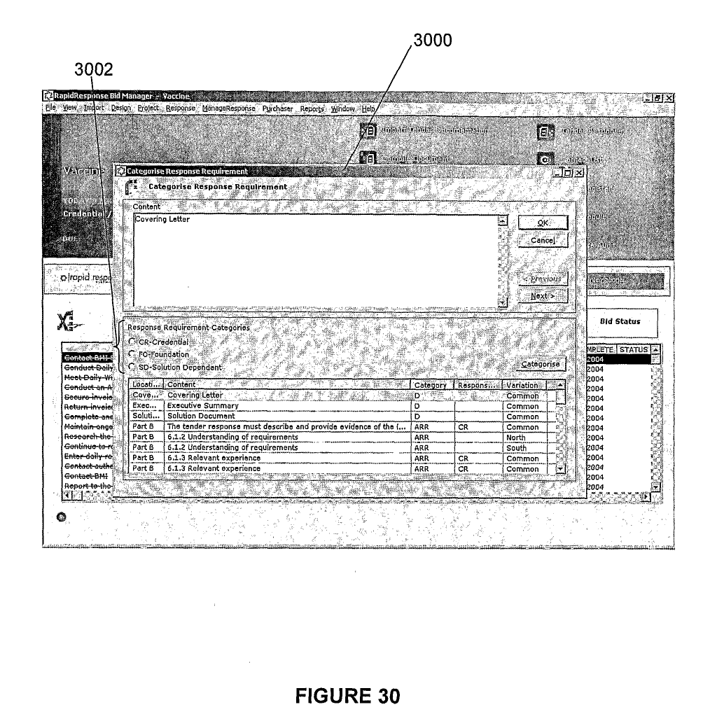

At step 706, the clauses identified in the categories of response requirement (D) and additional response requirement (ARR) can be further categorised at step 706 using a Categorise Response Requirement window 3000, as shown in FIG. 30. Each response requirement can be categorised as credential, foundation, or solution dependent, using radio buttons 3002.

Credential response requirements are Response Requirements relating to the Credentials of the bidding party that are relevant to the work being tendered for. Suitable responses can include existing referees, case studies, reference sites, and so on.

Foundation response requirements are Response Requirements relating to the business documentation and systems that form the foundation of the work being tendered for. Suitable responses can include existing details of the bidding party's quality management systems, risk management systems, and any other relevant business processes and procedures.

Solution-dependent response requirements are Response Requirements that directly reflect the solution offered to the purchaser and will therefore not be in existence and will have to be developed specifically for the tender opportunity.

At step 708, variations can be assigned to individual response requirements. A variation is used when the Purchaser packages the tender opportunity into segments and allows bidders to bid for those segments, and therefore requires the Tenderer to submit a response variation specific to that segment. For example, the tender opportunity may be divided into geographic regions such as a North Region and a South Region. In such cases, bidders are required to submit separate bids for each segment they wish to bid for.

When a user creates variations, the bid management system manages multiple bid documents throughout the life of the project. Accordingly, users can assign either a variation or a “Common” attribute to each response requirement, where Common is the default setting. If a variation is selected, a copy of the selected response is created for each variation. For example, the initially Common response requirement “Question One” may become “Question One North” and “Question One South”.

Foundation Response Requirements refer to business collateral that is common to all bids, irrespective of what service or variation is being tendered for. Foundation Response Requirements are therefore given a ‘Common’ attribute. Credential and Solution Dependent Response Requirements are customised for each segment of work tendered and are therefore given a variation attribute.

When editing a compiled document, any changes made to Common response requirements are reflected across each bid document variation, whereas changes made to a variation response requirements only affects the response requirement for that bid document variation.

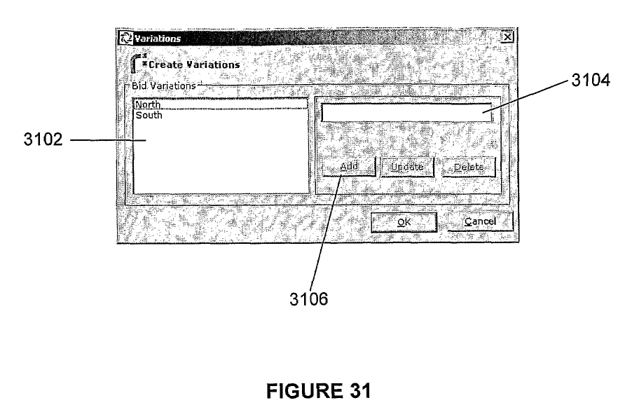

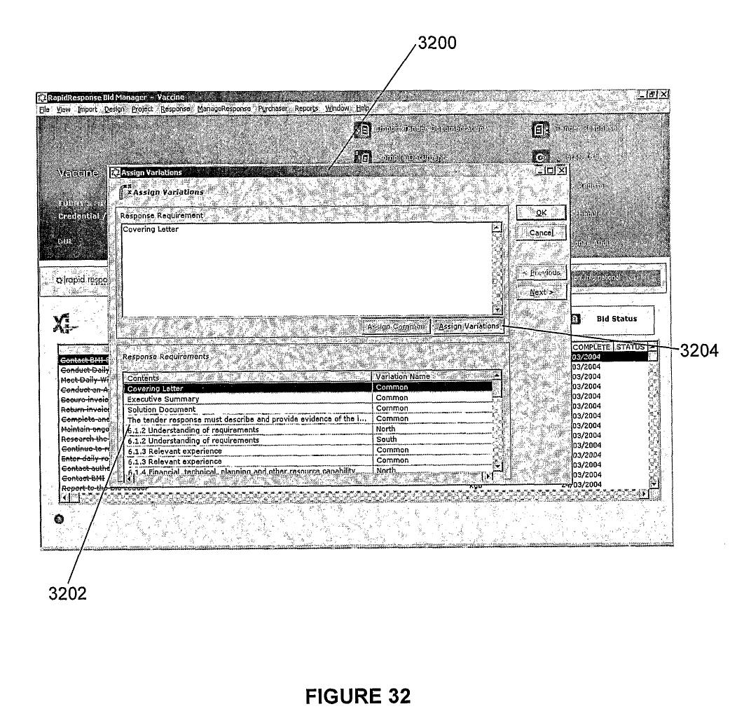

As shown in FIG. 31, a list of existing variations is displayed in a Bid Variations panel 3102, and a new variation can be created by entering a variation name into a variation name text box 3104, and selecting an Add Variation button 3106. Once a variation has been created, individual response requirements can be assigned the variation attribute using an Assign Variations window 3200, as shown in FIG. 32. By selecting an individual response requirement in a displayed list 3202 of response requirements, an Assign Variations button 3204 can be clicked to assign variations to the selected response requirement. The user then can select one or more of the available variations, and for each selected variation, a copy of the response requirement is created. For example, the list of response requirements 3202 shown in FIG. 32 includes two copies of a requirement “6.1.2 Understanding of requirements”, with the variations North and South.

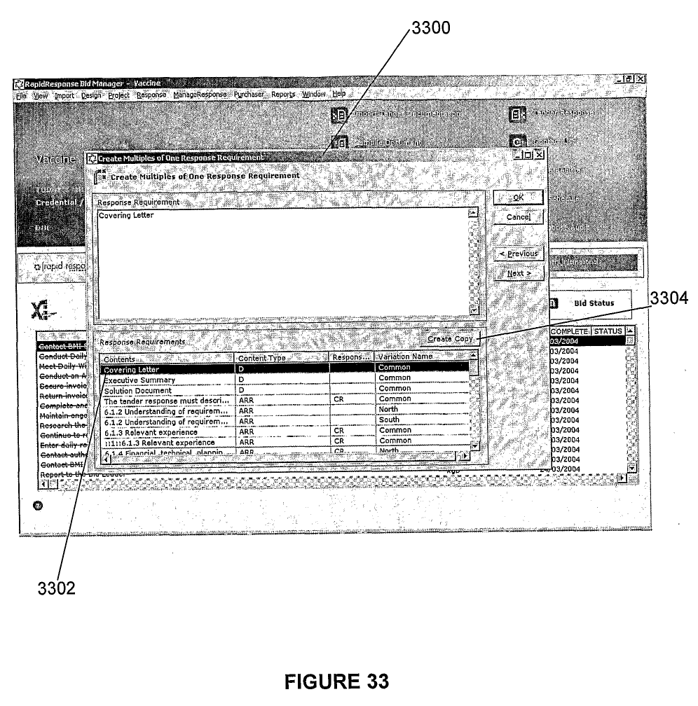

Sometimes the Purchaser requires responses to be supplied several times if there are a number of parties submitting the bid. This is different to the Bid Variation function because it generates a copy of a response requirement within a single bid document, not an entirely new bid document. For example, users can duplicate Response Requirements for the required number of authors. At step 710, multiples of a response requirement can be created using a Create Multiples window 3300, as shown in FIG. 33. A copy of an existing response requirement is created by selecting the requirement from a requirement list 3302, and then selecting a Create Copy button 3304. The Response Requirements is copied in the database 118, and renamed.

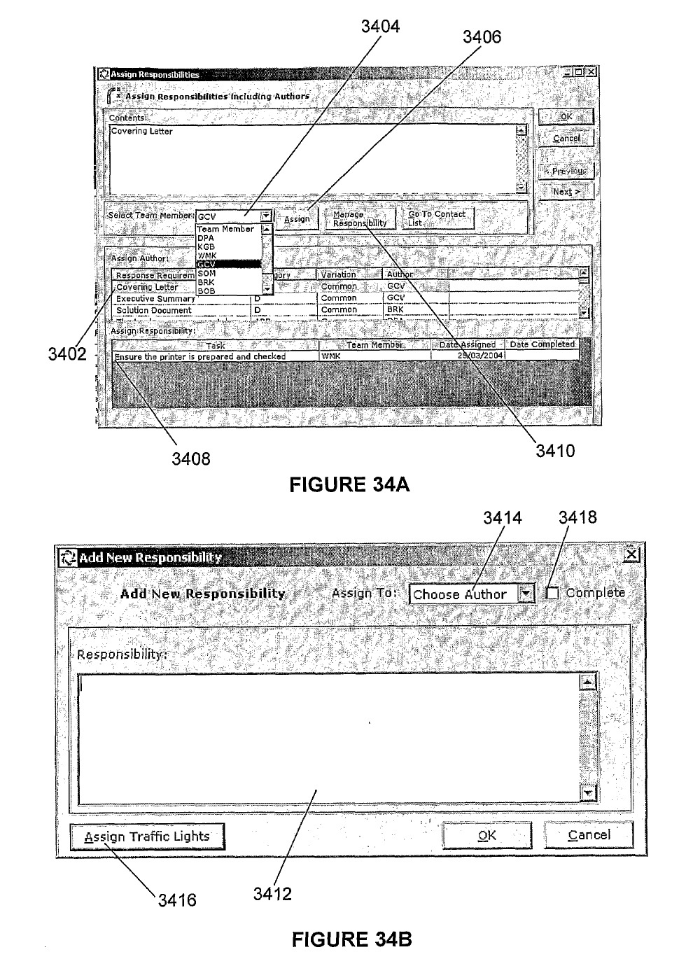

At step 712, responsibility for the completion of each response requirement is assigned to a selected user as the author of that response requirement. As shown in FIG. 34A, this is achieved by selecting a response requirement from a displayed list 3402, selecting a Contact from a drop-down menu 3404, and then selecting an Assign button 3406. The drop-down menu of contacts 3404 includes Authors and bid team members. Additionally, a Responsibility can be selected from the list of Responsibilities 3408, and the responsibility assigned to a Contact in the same manner. Additional Responsibilities can be created during the project by selecting a Manage Responsibility button 3410 which results in the display of an Add New Responsibility Window, as shown in FIG. 34B. A textual description of the new responsibility is entered into a Responsibility Text Box 3412. A drop-down menu 3414 allow the new responsibility to be assigned to a contact. An assign traffic lights button 3416 allows the user to assign traffic light dates to the new responsibility, as described above. A Complete check box 3418 can be checked to indicate that the new task has already been completed.

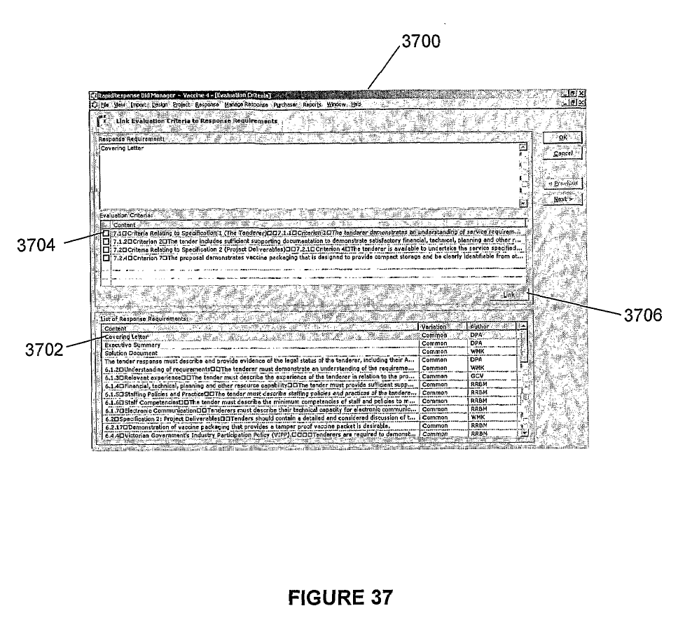

An important feature of the bid management system is the ability to evaluate a bid in progress to estimate the likelihood of success and to monitor improvements in this evaluation as a result of subsequent modifications. At step 714, each clause categorised as an evaluation criterion (EC) at step 704 is selected from a list of evaluation criteria 3602 and the user then indicates whether the selected criterion is applicable to the response, to the solution document, or has no connection to the bid, by selecting the appropriate type option from an Evaluation Criteria Type pull down menu 3604. After the evaluation criteria have been typed, the evaluation criteria in the first two categories are linked to individual response requirements at step 716, using an Evaluation Criteria to Response Requirements window 3700, as shown in FIG. 37. This is achieved by selecting a response requirement from a scrollable list 3702, selecting one or more evaluation criteria from a list 3704, and selecting a Link button 3706 to link the selected criteria with the selected response requirement.

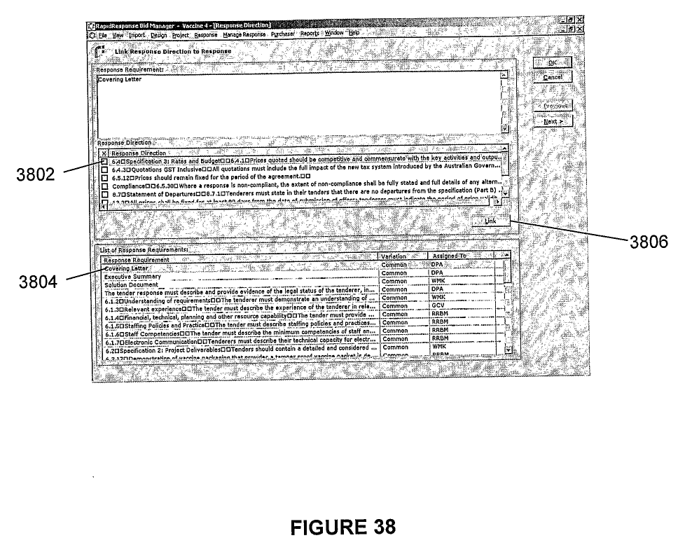

A tender typically includes a number of response directions that apply to one or more response requirements. As described above, any Response Directions in the tender document are categorised as such at step 704. As shown in FIG. 38, the linking of individual response directions to response requirements can be achieved at step 718 by selecting one or more response directions from a list of response directions 3802, selecting a corresponding response requirement from a list of response requirements 3804, and then selecting a Link button 3806 to establish a link between the selected response directions and the selected response requirement.

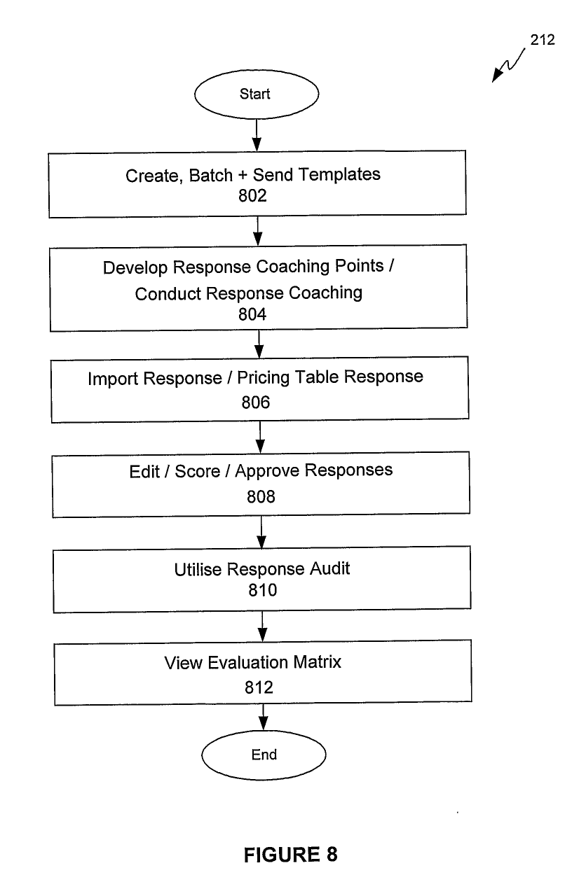

Returning to FIG. 2, once the tender document import and categorization process 212 has been completed, a response management process 212, as shown in FIG. 8, allows the bid manager and/or assistant bid managers to manage the creation and refinement of individual responses made by one or more response authors.

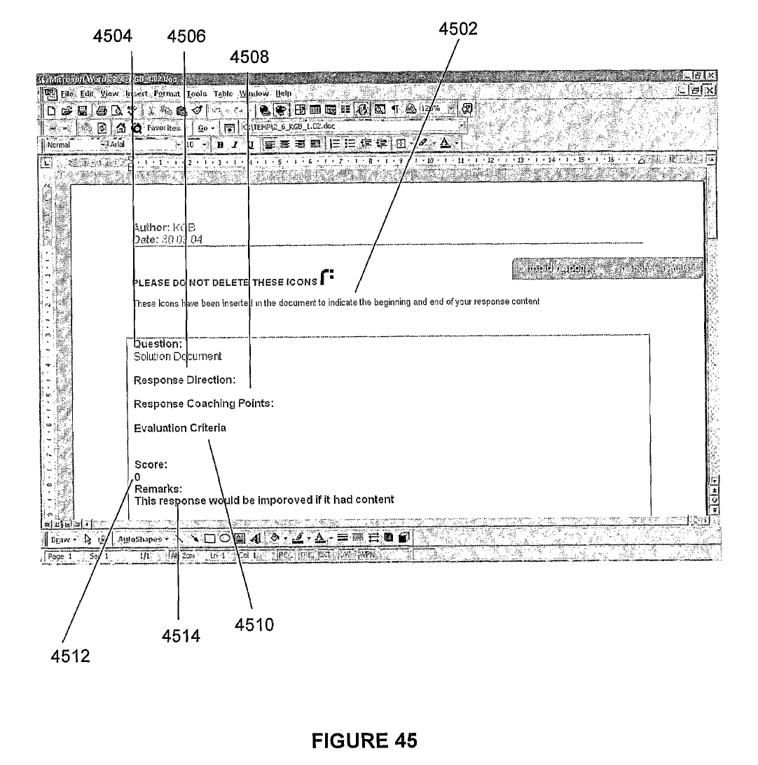

The bid management system generates a response template for each response requirement to facilitate the development of responses by response authors. Each response template includes the following major sections: (i) a header, (ii) a section containing information previously elected to be displayed by the user, and (iii) a section headed “Enter Response Here” where Authors enter their response between two icons. As shown in FIG. 45, the template header is a locked field that contains:
(i) the corresponding Response Requirement 4504;
(ii) any Evaluation Criteria linked to the response requirement 4510;
(iii) any Response Directions linked to the response requirement 4506;
(iv) any Response Coaching Points 4508 (only populated with data after the BM/ABM edits the first draft of the response);
(v) a Score given to the author's response by the Bid Manager (BM) or an Assistant Bid Manager (ABM) 4512 (only populated with data after the BM/ABM edits the first draft of the response); and
(vi) Remarks 4514 (only populated with data after the BM/ABM edits the first draft of the response).

The templates are created in Microsoft Word format. Each response template is then sent to the appropriate author(s) by email. An author receiving a response template then prepares their response by entering it directly into the template document. After completing their response, the author emails the completed template document back to the bid management system. The bid manager or an assistant bid manager then reviews the completed response template and can add remarks 4514 on the author's response and a numeric score 4512 into the locked header. The response request clause for which the author is to prepare a response is displayed under the header to facilitate preparation of the response text, which the Author enters in the space just beneath the header.

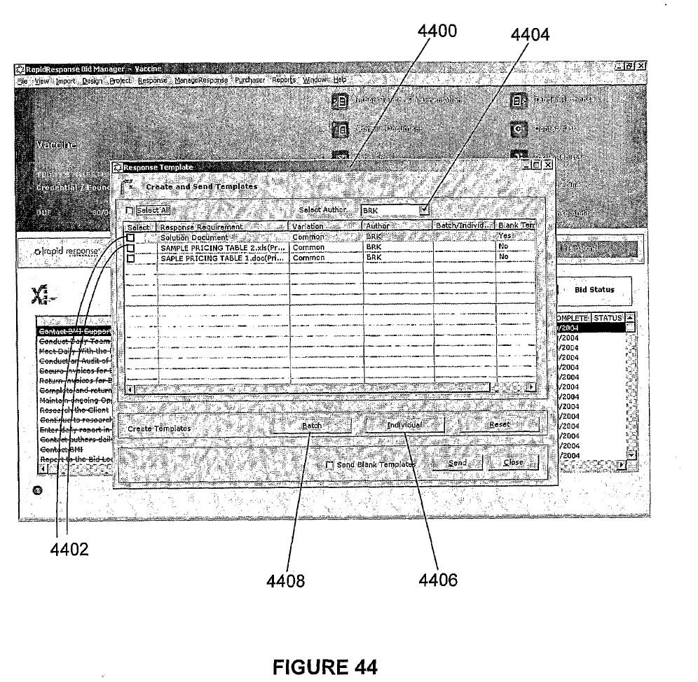

As shown in FIG. 44, response templates are managed at step 808 using a Create and Send Templates window 4400. The Create and Send Templates window 4400 allows a user to configure their response templates before sending them to authors. In particular, the user can generate a response template document for more than one response requirement. This is referred to as batching the response requirements, and it particularly useful when a single author is to provide responses for more than one response requirement. When response requirements are batched, the resulting Response Template document includes all batched responses and their template headers in the order that the Responses were imported into the program at step 210. Individual templates can be selected using selection boxes 4402 adjacent to respective response requirements, and the selected templates can be sent to a particular author selected from an Author Selection pull-down menu 4404. A response template can be created for an individual response by selecting a Create Individual Template button 4406, or for two or more responses by selecting a Create Batch Template button 4408.

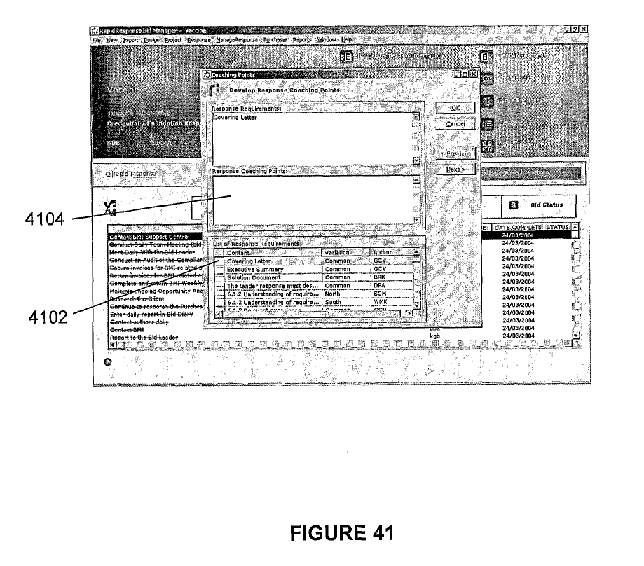

As shown in FIG. 41, the user can use a Coaching Points window 4100 to add response coaching points at step 804 by selecting a response requirement from a list 4102, and then entering one or more response coaching points for the selected response requirements in a text box 4104. Any response coaching points will be displayed in the response template sent to the author of the corresponding response and are provided to assist and guide the author when preparing his or her response text in order to improve the quality of the response. This facility allows the bid manager or an assistant bid manager to automate and manage the coaching of individual authors, assisting them to prepare the corresponding response.

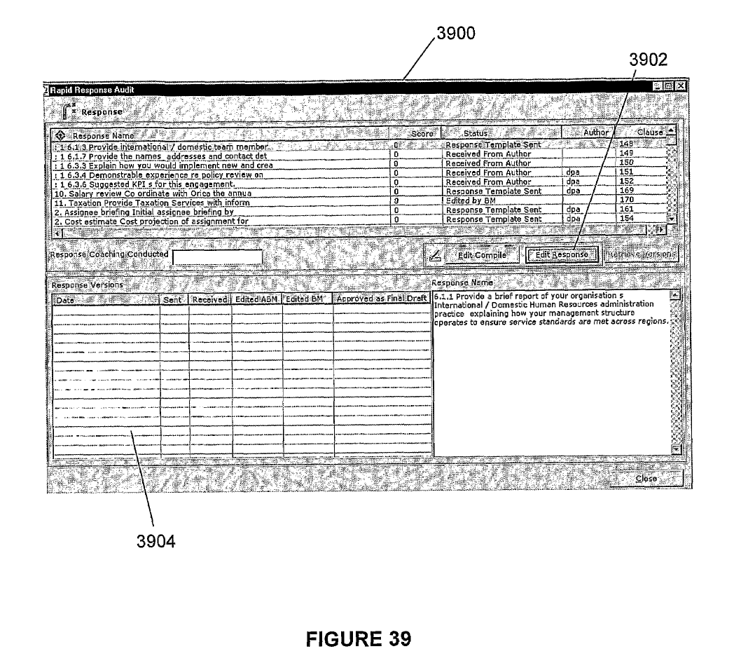

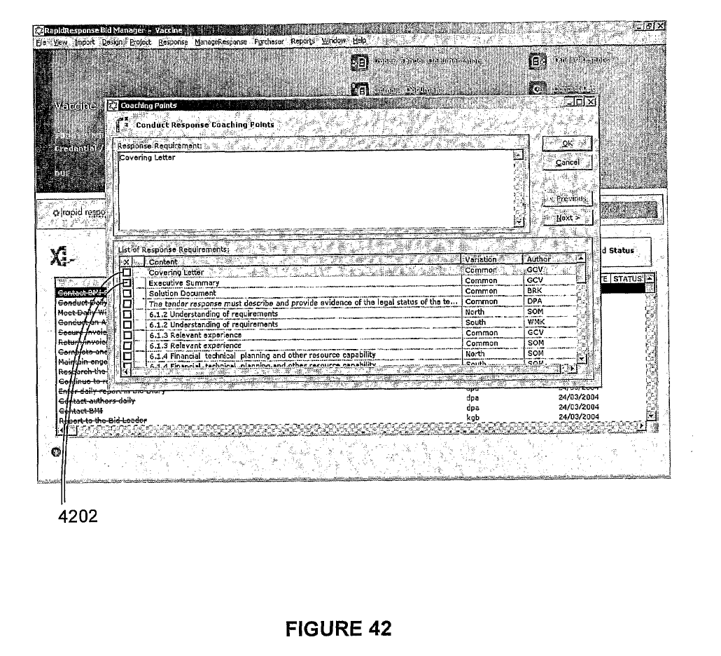

When the coaching has been conducted; i.e., when the user has ensured that the author of the corresponding response has viewed the coaching point and has hopefully improved the response, the user can use a Conduct Response Coaching Points window 4200, as shown in FIG. 42, to indicate that the coaching for a particular response has been conducted by selecting a checkbox 4202 beside the corresponding response requirement from a list 4204. Once marked, the date and time that the response coaching was conducted is displayed with the corresponding response requirement in a Response Audit screen 3900, as shown in FIG. 39. This allows the bid manager and assistant bid managers to determine whether a particular response has already been coached.

When a completed response template document is received from an author, the bid management system imports the completed response template at step 806 and, in the case of a batch response template including more than one response, separates the individual responses and their corresponding response requirements so that each individual response version can be individually tracked.

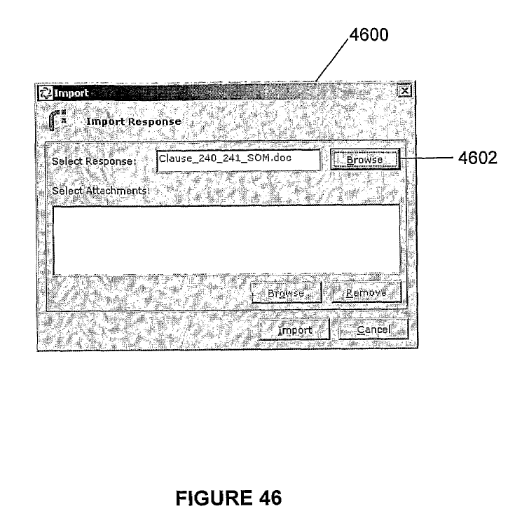

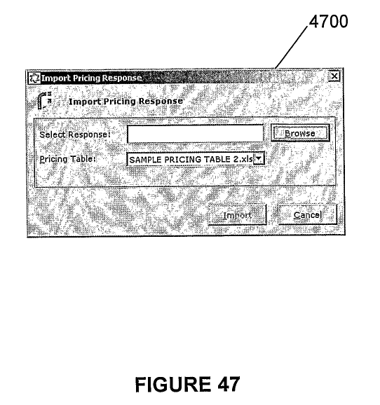

As described above, a response author receives the response template or templates via e-mail, and enters their response in the place provided. When returned to the Bid Manager or Assistant Bid Manager by email, the completed Response Template is saved to disk and then imported back into the bid management system. As shown in FIG. 46, this is achieved at step 810 by selecting the response template document from a file browser launched in response to selection of a Browse button 4602 in an import response window 4600. As shown in FIG. 45, each template includes icons 4502 at the beginning and end of the response content to allow the bid management system to automatically extract the response content and store it in the database 118. Users can elect to import a response document more than once, but will be issued with a warning should they choose to do so. As shown in FIG. 47, pricing tables can also be imported using an import pricing response window 4700.

When a response is imported, the system saves the new version of the response by incrementing a version number associated with the response. When importing a batched response, the system generates an alert message indicating which response requirements (if any) have not been provided with a response. If a response is not received, there is no response to save and hence the version number of that response is not changed. After importing a response, the user performing the import is asked whether they wish to edit the response. If they elect to do so, the response template is opened for editing in Microsoft Word. If they choose not to Edit the response, they are returned to the Main portal window 2400, however the response can be edited at a later time.

As shown in FIG. 39, the bid management system allows a user to audit individual responses at step 810 using a Response Audit window 3900, as shown in FIG. 39. The response Audit window 3900 allows the user to view the status all response requirements and their associated versions. An Edit Response button 3902 can be selected to view and/or edit responses.

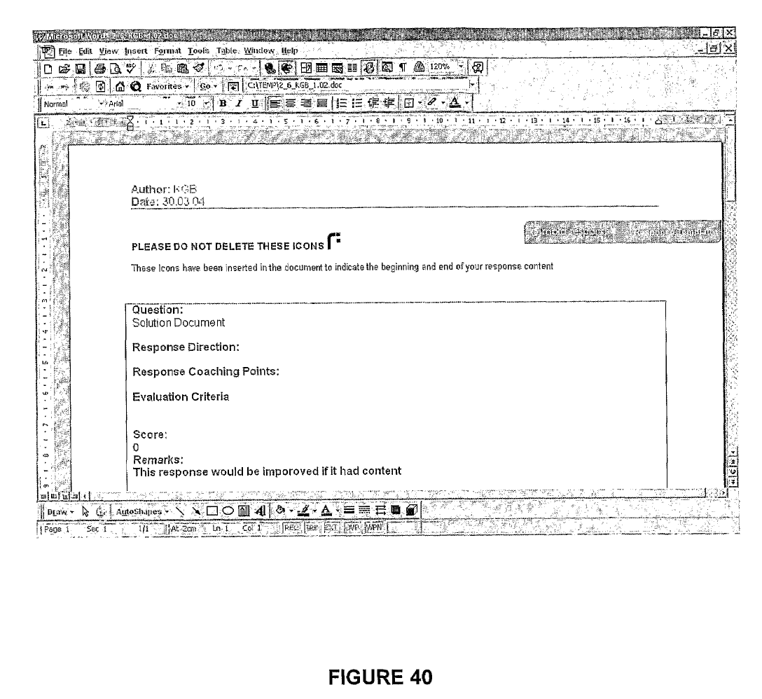

Version Numbers are updated when a response template is created, sent, received from an author, or edited, or when changes are made to a compiled document, or a response is approved as a final draft. If an old version of a response is double clicked, the response is opened read-only and displayed using Microsoft Word, as shown in FIG. 40.

The version Numbers are displayed in corresponding columns of a Response Versions panel 3904 of the Response Audit window 3900. Version numbers are assigned as follows. Major versions of a response requirement are numbered 1.0, 2.0 . . . and minor versions are numbered as 1.01, 1.02, 1.03, and so on. Every time a template is sent to the author through the Create and Send Template window 4400, its version number is set to 1.00. An incremental major version is created for every response received from the author. Every version edited by the user is assigned an incremental minor version and its status is set to “Edited by BM/ABM”. The author for a minor version continues to be author of the corresponding major version; this is true even in cases where the BM or an ABM edits the response anytime in the future. If the BM/ABM defines the response as Approved as Final Draft, a new record is visible in the Response Audit window 3900, but the version remains the same as that of the response.

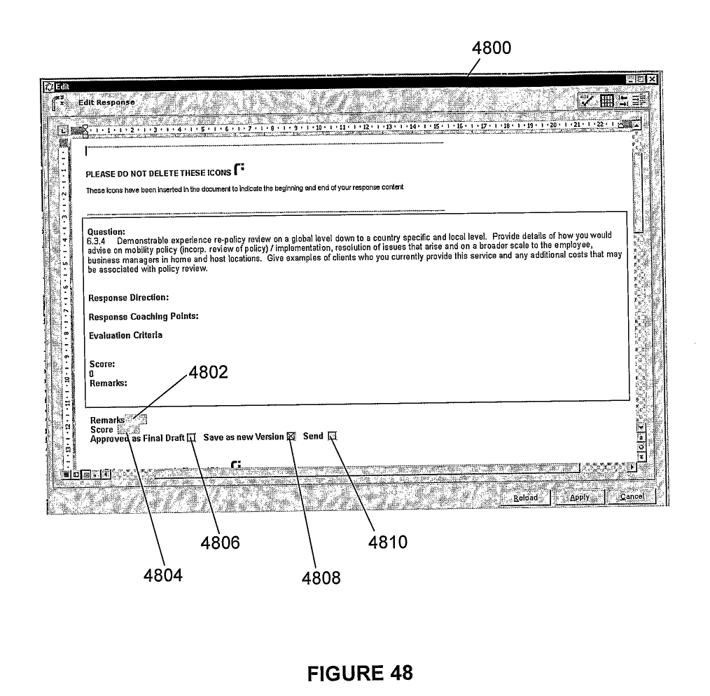

Once imported, a response can be edited, scored, and/or approved at step 808 by launching an Edit Response window 4800, as shown in FIG. 48. If a response requirement is defined as Common (e.g., to any variations), then any changes made to this response requirement are reflected across the separate bid documents being submitted. This reduces the effort wasted on making a single change across multiple documents.

The Edit Response window 4800 is also used by the bid manager or an assistant bid manager to evaluate an author's response to a response requirement. Significantly, the response is scored as though it were being evaluated in an actual procurement process. A scoring control 4804 is therefore included under each response. As described below, the user enters a score here which is then copied into the Evaluation Matrix as described above, and included in the template returned to the author. Users also have the opportunity to insert remarks into a text control 4802 that is also returned to the author with the response. Users can elect to edit a single response or to compile two or more responses and edit them together. The system tracks versions of each response, and not the file containing the response. Therefore users have the added benefit of being able to track the history of individual responses and view all versions of a response.

From the Edit Response window 4800, the response can either be returned to the author by selecting a send check box 4810, or approved as the final draft by selecting an Approved checkbox 4806. Those responses that are approved as final draft are shown as such in the Response Audit window 3900 described above. Should a user elect to return the response to its author, two actions can result. In the case of a single response, the template is attached to a new email message and the author's email address copied into the destination address field. In the case of a batched or compiled response, the Create and Send Templates window 4400 is displayed, and the responses that were marked to be returned to the author are listed, ready for sending. Should the user choose not to send the response templates at this time, the Create and Send Templates window 4400 is closed, and the unsent responses will have a Pending Sent to Author flag against them the next time the Create and Send Templates window 4400 is displayed.

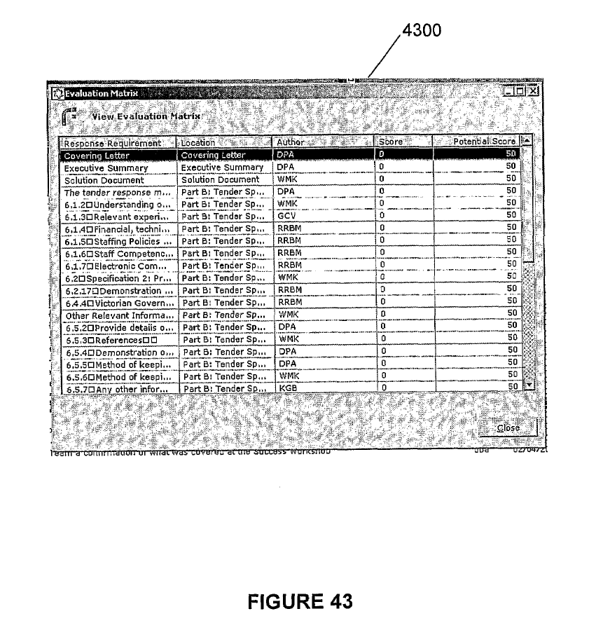

At step 812, an evaluation matrix can be displayed in a View Evaluation Matrix window 4300, as shown in FIG. 43. The View Evaluation Matrix window 4300 lists each response requirement together with its location in the bid document and the author of the corresponding response, together with a score for the response, and displays this next to a potential score for that response. Scores are added by the Bid Manager or an Assistant Bid Manager, as described above. Responses are scored at step 808 according to the following Table.

| Score | Condition |
|---|---|
| 0 | Response not provided. |
| 1 to 4 | Response is confusing, is incomplete, or does not address the |
| | question. |
| 5 | Response answers the question in a very basic way. |
| 6 to 7 | Response answers the question and provides some evidence in |
| | support of the response. |
| 8 to 10 | Response answers the question, is customised to the purchase |
| | requirement, and provides strong evidence in support of the |
| | response. |

Users score each response against the criteria provided in the above Table, and these scores are then provided in the evaluation matrix. The responses can then be evolved over time to ensure that the highest possible score is achieved.

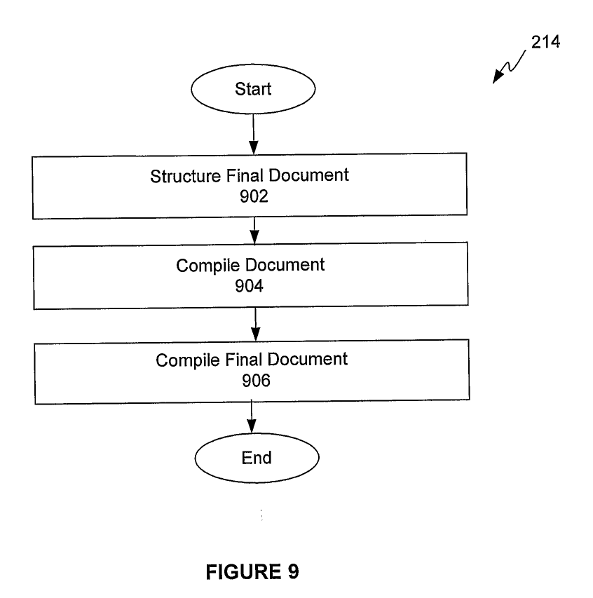

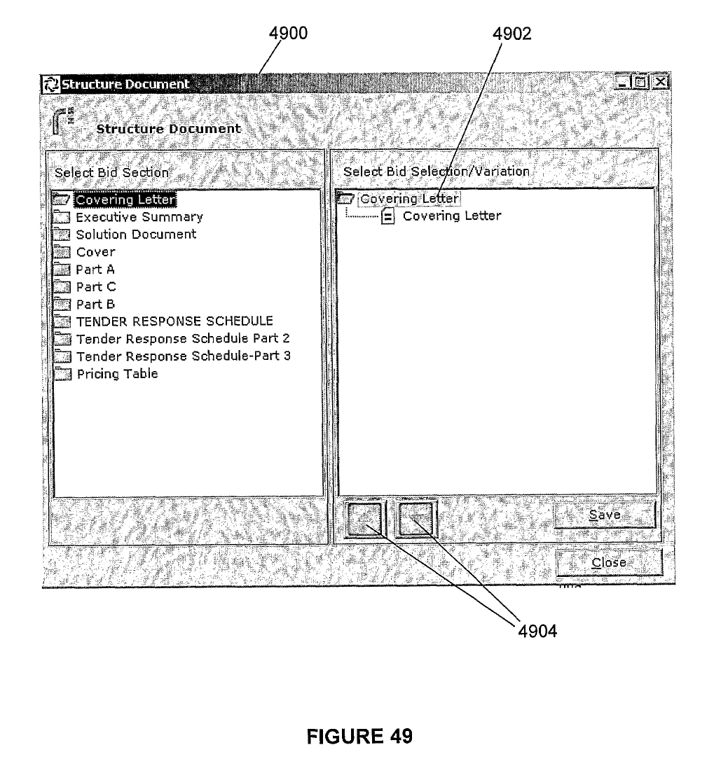

Returning to FIG. 2, once the author responses have been developed and finalised during the response management process 212, a bid document compilation process 214, as shown in FIG. 9, can be used to compile the final bid document. The final document can be structured at step 902 using a Structure Document window 4900, as shown in FIG. 49. This window 4900 allows the user to determine the order in which response requirements will appear in the final bid document. The window 4900 displays the sections defined by users in the Location field of the Clause Categorisation window 2800. Users can either arrange response requirements within a section or move response requirements between sections. A pricing tables folder contains pricing tables which cannot be arranged or moved to other sections. Other standard sections include Covering Letter, Solution Document, and Executive Summary. Documents in these sections also cannot be arranged or moved to other sections. The order in which the response requirements appear in the right hand side 4902 of the Structure Document window 4900 is the order that they will appear in the selected section in the Compile Document and Compile Final Document windows 5000, 5100, as described below. Using drag and drop or the ordering arrows 4904, users can change the order of the response requirements as they will appear in a compiled bid document.

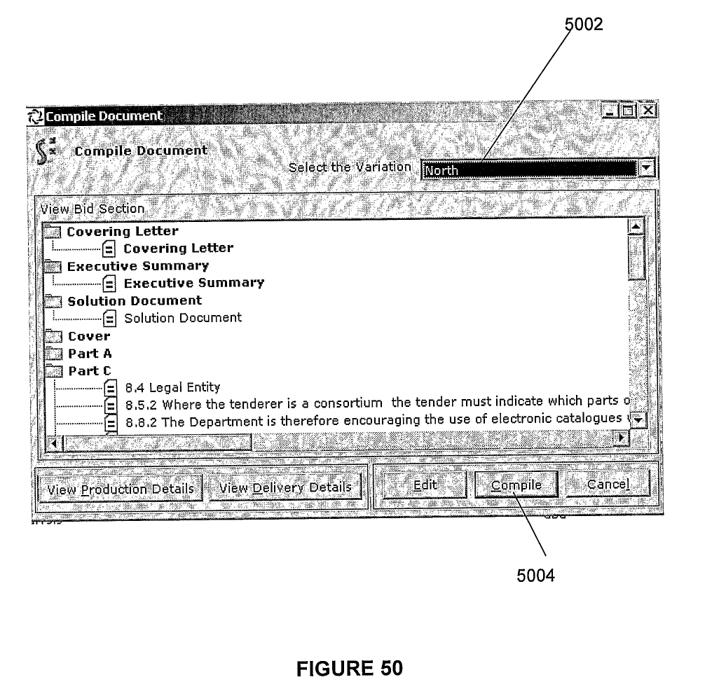

A bid document for a particular variation and section can be compiled at step 904 by selecting a Compile Document control 5006 in the main portal window 2400, which results in display of a Compile Document window 5000, as shown in FIG. 50. The compilation is performed by selecting the desired variation (if any) from a Variation pull-down menu 5002, selecting a Section, and selecting a Compile button 5004 to compile the selected section of the bid document. Bid sections for variation documents look identical, but when compiled, the content for those response requirements assigned by the user as Variation using the Assign Variations window 3200 as described above will be the content provided for the selected variation. The compiled document contains all response requirements and responses for the selected variation and section. Any editing changes made to the compiled document are tracked by the system.

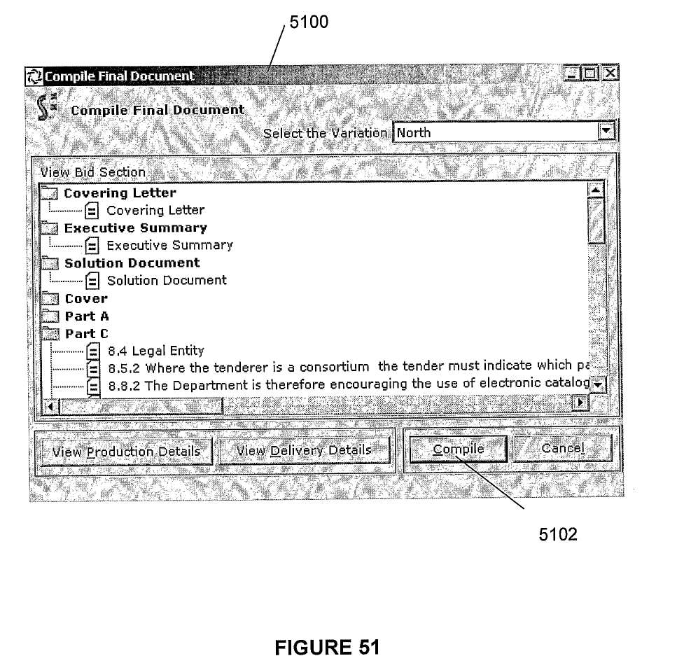

The final document can be compiled at step 906 for printing or editing using a Compile Final Document window 5100, as shown in FIG. 51. The compilation is carried out in the order that the user has defined in the Structure Final Document window 4900, and should only be performed once all responses have been reviewed and approved as final draft, and their content will not change. The final document can only be compiled by the user assigned this task in the task list—it is not available in the main portal window 2400. The compilation of the final document should be performed once only during a bid. If the final document is compiled more than once, the existing final document is replaced by the newly created final document. Once a user selects the Compile Final Document button 5102, the compilation is performed using the master document-subdocument features of Microsoft Word. As this occurs outside of the bid management system, any changes to the final document itself is not tracked by the system. However, the final document is stored in a disaster recovery folder on the user's client system 106, which contains:
(i) the latest versions of all responses and the latest compiled (final) document;
(ii) a text file with the project details—project name, description, backup creation date and time; and
(iii) a server folder containing all project files.

The allows users to continue working on the bid project even if they no longer have access to the network or the server 104.

Many modifications will be apparent to those skilled in the art without departing from the scope of the present invention as herein described with reference to the accompanying drawings.

1. A system for managing the preparation of a bid document in response to a tender, the system including:
a clause categorisation component for receiving clause data including a plurality of clauses selected from a tender document and for categorising each of said clauses by associating each clause with a clause category selected from a plurality of predetermined clause categories;
a database for storing said clause data and the clause category associated with each clause of said clause data;
an author association component for associating each clause categorised as a response requirement with a corresponding response author;
a messaging component for sending a response template including at least one response requirement to a response author associated with the at least one response requirement, and for receiving a corresponding completed response template from said response author, the completed response template including response text prepared by said response author in response to the at least one response requirement; and
a bid document generator for generating a bid document on the basis of the response text received from response authors associated with the response requirements of the tender document.

2. The system of claim 1, including a scoring component for associating a response score with the response text received from a response author, the response score indicating the quality of the associated response text; wherein the response score and the response text are included in a second response template sent to the response author to facilitate revision of the response text.

3. The system of claim 2, wherein the system is adapted to generate an overall score for the bid document on the basis of the scores associated with response text.

4. The system of claim 1, wherein the system is adapted to receive approval data to indicate that corresponding response text is approved for inclusion in the bid document.

5. The system of claim 4, wherein the system is adapted to generate a response completion score representing the proportion of response requirements for which response text has been received and approved for inclusion in the bid document.

6. The system of claim 1, including a coaching component for inserting one or more coaching points in a response template to guide a corresponding response author in the preparation of response text.

7. The system of claim 1, including a response audit component for generating response audit data to display each response requirement, a response author associated with the response requirement, a response score associated with the corresponding response text received from the response author, and status data associated with the response requirement.

8. The system of claim 1, wherein said clause categories correspond to one or more of responsibility, condition of tender, delivery direction, production direction, condition of contract, response requirement, additional response requirement, response direction, evaluation criteria, primary output, secondary output, outcome procurement, outcome service delivery, key performance indicator, and vendor response narrative.

9. The system of claim 1, wherein said clause data includes location data indicating the location of each response requirement in the tender document and a descriptive name given to each response requirement.

10. The system of claim 1, wherein said clause data includes text for inclusion in corresponding response text prepared in response to a response requirement.

11. The system of claim 1, including a response direction linking component for associating at least one clause categorised as a response direction with at least one response requirement.

12. The system of claim 1, including an evaluation criteria linking component for associating at least one clause categorised as an evaluation criterion with at least one response requirement.

13. The system of claim 1, including an evaluation criteria categorisation component for categorising at least one clause categorised as an evaluation criterion as being applicable (i) to a response of the bid document, (ii) to a solution document of the bid document, or (iii) as having no connection to the bid document.

14. The system of claim 1, including a response requirement categorisation component for further categorising each response requirement to indicate that the response requirement:
(i) relates to credentials of a bidding party;
(ii) relates to systems and processes of the bidding party; or
(iii) is specific to the bidding party's bid.

15. The system of claim 1, including a variation generator for generating variations of selected response requirements to allow variations of the bid document to be generated for respective segments of a tender.

16. The system of claim 1, including a response duplicator for generating a copy of a selected response requirement for which response text is to be included more than once in the bid document.

17. The system of claim 1, wherein each response template includes delimiters for use in extracting response text from a completed response template.

18. The system of claim 1, wherein the response template includes a locked template header including at least one response requirement, one or more evaluation criteria from the tender document for evaluating the corresponding response text, and one or more response directions from the tender document.

19. The system of claim 18, wherein the template header further includes one or more coaching points for coaching a response author of the response text, one or more remarks on the response text previously received from the response author, and a score for the previously received response text.

20. The system of claim 1, including a template generator for generating one or more response templates for sending to response authors of corresponding response text.

21. The system of claim 1, wherein the system is adapted to generate version numbers for respective versions of response text for a response requirement.

22. The system of claim 1, including:
a task generation component for selecting tasks for preparing the bid document from a plurality of predetermined tasks, and for associating a selected user and a completion date with each of the selected tasks; and
a monitoring component for generating status data indicating the status of each of the selected tasks.

23. The system of claim 22, including a Gantt chart generator for generating a Gantt chart for the selected tasks.

24. The system of claim 1, including a task status component for generating visual status data representing a status of each task as one of a plurality of predetermined colours representing respective states of each task, the colour associated with a task being selected on the basis of a comparison of the current date with dates associated with the task.

25. A system for managing the preparation of a bid document in response to a tender, the system including:
a task generation component for selecting tasks for preparing the bid document from a plurality of predetermined tasks, and for associating with each of the selected tasks a due date for completion of the task and a user responsible for said completion;
a task status component for updating status data associated with each selected task, the status data including the due dates for completion of said tasks and completion data indicating dates on which respective tasks were completed by users responsible for completion of said tasks; and
a bid status component for generating status display data representing the status of each task on the basis of the due dates associated with said tasks.

26. The system of claim 25, wherein the task generation component is adapted to select tasks on the basis of the time available for preparing the bid document.

27. The system of claim 25, wherein the system is adapted to add tasks corresponding to respective response requirements of said tender.

28. The system of claim 25, including
a clause categorisation component for receiving clause data including a plurality of clauses selected from a tender document and for categorising each of said clauses by associating each clause with a clause category selected from a plurality of predetermined clause categories;
an author association component for associating each clause categorised as a response requirement with a corresponding response author;
a messaging component for sending a response template including at least one response requirement to a response author associated with the at least one response requirement, and for receiving a corresponding completed response template from said response author, the completed response template including response text prepared by said response author in response to the at least one response requirement; and
a bid document generator for generating a bid document on the basis of the response text received from response authors associated with the response requirements of the tender document.

29. The system of claim 25, including a task status component for generating visual status data representing a status of each task as one of a plurality of predetermined colours representing respective states of each task, the colour associated with a task being selected on the basis of a comparison of the current date with dates associated with the task.

30. The system of claim 25, wherein the system is adapted to receive response text corresponding to response requirements of the tender; and to generate a bid document on the basis of the received response text.

31. The system of claim 25, wherein the system is adapted to generate a new instance of a selected task on a daily basis.

32. A process for managing the preparation of a bid document in response to a tender, the process executed by a computer system and including:
receiving clause data including a plurality of clauses selected from a tender document;
categorising each of said clauses by associating each clause with a clause category selected from a plurality of predetermined clause categories;
associating each clause categorised as a response requirement with a corresponding response author;
sending a response template including at least one response requirement to a response author associated with the at least one response requirement;
receiving a corresponding completed response template from said response author, the completed response template including response text prepared by said response author in response to the at least one response requirement; and
generating a bid document on the basis of the response text received from response authors associated with the response requirements of the tender document.

33. The process of claim 32, including associating a response score with the response text received from a response author, the response score indicating the quality of the associated response text; wherein the response score and the response text are included in a second response template sent to the response author to facilitate revision of the response text.

34. The process of claim 33, including generating an overall score for the bid document on the basis of the scores associated with response text.

35. The process of claim 32, including receiving approval data indicating that corresponding response text is approved for inclusion in the bid document.

36. The process of claim 35, including generating a response completion score representing the proportion of response requirements for which response text has been received and approved for inclusion in the bid document.

37. The process of claim 32, including inserting one or more coaching points in a response template to guide a corresponding response author in the preparation of response text.

38. The process of claim 32, including generating response audit data to display each response requirement, a response author associated with the response requirement, a response score associated with the corresponding response text received from the response author, and status data associated with the response requirement.

39. The process of claim 32, wherein said clause categories correspond to one or more of responsibility, condition of tender, delivery direction, production direction, condition of contract, response requirement, additional response requirement, response direction, evaluation criteria, primary output, secondary output, outcome procurement, outcome service delivery, key performance indicator, and vendor response narrative.

40. The process of claim 32, wherein said clause data includes location data indicating the location of each response requirement in the tender document and a descriptive name given to each response requirement.

41. The process of claim 32, wherein said clause data includes text for inclusion in corresponding response text prepared in response to a response requirement.

42. The process of claim 32, including associating at least one clause categorised as a response direction with at least one clause categorised as a response requirement.

43. The process of claim 32, including associating at least one clause categorised as an evaluation criterion with at least one clause categorised as a response requirement.

44. The process of claim 32, including further categorising at least one clause categorised as an evaluation criterion as being applicable (i) to a response of the bid document, (ii) to a solution document of the bid document, or (iii) as having no connection to the bid document.

45. The process of claim 32, including further categorising each response requirement to indicate that the response requirement:
(i) relates to credentials of a bidding party;
(ii) relates to processes and processes of the bidding party; or
(iii) is specific to the bidding party's bid.

46. The process of claim 32, including generating variations of selected response requirements to allow variations of the bid document to be generated for respective segments of a tender.

47. The process of claim 32, including generating a copy of a selected response requirement for which response text is to be included more than once in the bid document.

48. The process of claim 32, wherein each response template includes delimiters for use in extracting the response text from a completed response template.

49. The process of claim 32, wherein the response template includes a locked template header including at least one response requirement, one or more evaluation criteria from the tender document for evaluating the corresponding response text, and one or more response directions from the tender document.

50. The process of claim 49, wherein the template header further includes one or more coaching points for coaching a response author of the response text, one or more remarks on the response text previously received from the response author, and a score for the previously received response text.

51. The process of claim 32, including generating one or more response templates for sending to response authors of corresponding response text.

52. The process of claim 32, including generating version numbers for respective versions of response text for a response requirement.

53. The process of claim 32, including:
selecting tasks for preparing the bid document from a plurality of predetermined tasks;
associating a selected user and a completion date with each of the selected tasks; and
generating status data indicating the status of each of the selected tasks.

54. The process of claim 32, including generating a Gantt chart for the selected tasks.

55. The process of claim 32, including generating visual status data representing a status of each task as one of a plurality of predetermined colours representing respective states of each task, the colour associated with a task being selected on the basis of a comparison of the current date with dates associated with the task.

56. A process for managing the preparation of a bid document in response to a tender, the process including:
selecting tasks for preparing the bid document from a plurality of predetermined tasks;
associating with each of the selected tasks a due date for completion of the task and a user responsible for said completion;
maintaining status data associated with each selected task, the status data including the due dates for completion of said tasks and completion data indicating dates on which respective tasks were completed by users responsible for completion of said tasks; and
generating status display data representing the status of each task on the basis of the due dates associated with said tasks.

57. The process of claim 56, wherein said selecting includes selecting tasks on the basis of the time available for preparing the bid document.

58. The process of claim 56, including adding tasks corresponding to respective response requirements of said tender.

59. The process of claim 56, including receiving clause data including a plurality of clauses selected from a tender document;
categorising each of said clauses by associating each clause with a clause category selected from a plurality of predetermined clause categories;
associating each clause categorised as a response requirement with a corresponding response author;
sending a response template including at least one response requirement to a response author associated with the at least one response requirement;
receiving a corresponding completed response template from said response author, the completed response template including response text prepared by said response author in response to the at least one response requirement; and
generating a bid document on the basis of the response text received from response authors associated with the response requirements of the tender document.

60. The process of claim 56, including generating visual status data representing a status of each task as one of a plurality of predetermined colours representing respective states of each task, the colour associated with a task being selected on the basis of a comparison of the current date with dates associated with the task.

61. The process of claim 56, including receiving response text corresponding to response requirements of the tender; and generating a bid document on the basis of the received response text.

62. The process of claim 56, including generating a new instance of a selected task on a daily basis.

63. (canceled)

64. A computer readable storage medium having stored thereon program instructions for performing a method, the method comprising:
receiving clause data including a plurality of clauses selected from a tender document;
categorizing each of said clauses by associating each clause with a clause category selected from a plurality of predetermined clause categories;
associating each clause categorized as a response requirement with a corresponding response author;
sending a response template including at least one response requirement to a response author associated with the at least one response requirement;
receiving a corresponding completed response template from said response author, the completed response template including response text prepared by said response author in response to the at least one response requirement; and
generating a bid document on the basis of the response text received from response authors associated with the response requirements of the tender document.

65. A computer readable storage medium having stored thereon program instructions for performing a method, the method comprising:
selecting tasks for preparing the bid document from a plurality of predetermined tasks;
associating with each of the selected tasks a due date for completion of the task and a user responsible for said completion;
maintaining status data associated with each selected task, the status data including the due dates for completion of said tasks and completion data indicating dates on which respective tasks were completed by users responsible for completion of said tasks; and
generating status display data representing the status of each task on the basis of the due dates associated with said tasks.
